(19) United States
(12) Patent Application Publication
(10) Pub. No.: US 2020/0010698 A1
(43) Pub. Date: Jan. 9, 2020

(54) METHOD FOR FORMING MULTILAYER COATING FILM

(71) Applicants: BASF Coatings GmbH, Münster (DE); Honda Motor Co. Ltd., Tokyo (JP)

(72) Inventors: Toru Kurashina, Yokohama-shi (JP); Kazuhiko Shinmura, Yokohama-shi (JP); Takeshi Tsunoda, Yokohama-shi (JP); Masuo Kondo, Saitama (JP); Keisuke Kojima, Saitama (JP)

(21) Appl. No.: 16/488,460

(22) PCT Filed: Mar. 12, 2018
(86) PCT No.: PCT/EP2018/056040

§ 371 Date: Aug. 23, 2019

(30) Foreign Application Priority Data
Mar. 31, 2017 (JP) 17/070940

(51) Int. Cl. C09D 5/24; C09D 5/00; C09D 123/02; C09D 175/04; C09D 175/06; C09D 175/08; C09D 5/02; C09D 133/04; C08J 7/04; B05D 7/00

(52) U.S. Cl. CPC C09D 5/24; C08J 2433/04; C09D 123/02; C09D 175/04; C09D 175/06; C09D 175/08; C09D 5/022; C09D 133/04; C08J 7/042; B05D 7/572; C08J 2323/12; C08J 2355/02; C08J 2369/00; C08J 2475/04; C08J 2475/06; C08J 2475/08; C08J 2423/02; C09D 5/002

(57) ABSTRACT

A method for forming a multilayer coating film is provided. The method includes coating at least one object with an aqueous primer coating composition, an aqueous first colored coating composition, an aqueous second colored coating composition, and a clear coating composition, in that order. The aqueous primer coating composition contains a component (A) which contains a polyolefin resin, a component (B) which contains a polyurethane resin, a curing agent (C) and electrically conductive carbon (D). The aqueous first colored coating composition and aqueous second colored coating composition each contain a core/shell emulsion. The clear coating composition contains a hydroxyl group-containing acrylic resin, a polyisocyanate and a melamine resin. The method improves the appearance, chipping resistance, adhesive properties and low temperature impact properties of a coating film.

### TECHNICAL FIELD

The present invention relates to a novel method for producing a multilayer coating film using aqueous coating compositions, which can be used in a variety of technical fields, and especially the field of motor vehicle coatings.

### BACKGROUND ART

In general, methods for forming multilayer coating films in which objects to be coated are motor vehicle bodies comprise forming an electrodeposition film on an object to be coated, curing the electrodeposition film by heating, and then forming a multilayer coating film comprising an intermediate coating film, a base coating film and a clear coating film. As a result of environmental concerns in recent years, aqueous films have come to be used as intermediate coating films and base coating films in order to reduce usage of volatile organic components (VOCs). In addition, as vehicle bodies have become lighter in recent years in order to improve fuel economy, materials for vehicle bumpers have become thinner.

In order to reduce the amount of energy consumed, many methods currently used for forming multilayer coating films involve so-called 3-coat-1-bake (3C1B) processes, which comprise forming a second base coating film and a clear coating film on a preheated first base coating film formed on an electrodeposition film, without heating and curing the first base coating film, and then simultaneously heating and curing these three coating films.

For example, Japanese Patent No. 5734920 (Patent Document 1) discloses a method for forming a multilayer coating film by using an aqueous base coating composition, which contains a core/shell emulsion resin having an acrylic resin core and a polyurethane resin shell as a base resin and contains a polyisocyanate compound and/or a polycarbodiimide compound as a curing agent, and a clear coating composition that contains a hydroxyl group-containing acrylic resin and a polyisocyanate compound. By using this method for forming a multilayer coating film, it is possible to lower the heating temperature required to cure coating films and further reduce energy consumption.

In addition, from the perspectives of reducing energy consumption and reducing the number of steps in the process, consideration has been given to coating methods in which the same coating materials are used for both steel sheets and plastic base materials. For example, Japanese Patent Application Publication No. 2011-131135 (Patent Document 2) discloses an aqueous base coating material that contains an acrylic resin emulsion, a water-soluble acrylic resin, a melamine resin and a propylene glycol monoalkyl ether; and a method for forming a multilayer coating film using this aqueous base coating material, and the acrylic resin emulsion is obtained by emulsion polymerization of a monomer mixture containing a crosslinkable monomer.

However, in order to be used on plastic base materials, the methods for forming multilayer coating films mentioned above are both unsatisfactory in terms of low temperature impact resistance in cases where a plastic base material is thin even if adhesion of a multilayer coating film to the plastic base material is ensured by applying a primer in advance.

In addition, it is common for small stones and the like to impact strongly on vehicles while in motion, and this can cause localized detachment of coating films. In order to form a coating film on a steel sheet, resistance to detachment caused by such impacts from small stones and the like (chipping resistance) is important, and excellent chipping resistance at low temperatures in particular is required.

For example, WO2011/010538 (Patent Document 3) discloses a method for forming a multilayer coating film by using an aqueous primer composition that contains a urethane resin emulsion and an oligomer. This urethane resin emulsion is produced using a polyisocyanate component and a polyol component as raw materials, and has a specific acid value and weight average molecular weight, and this oligomer has a water tolerance of at least 10 and a specific number average molecular weight. However, if the abovementioned method for forming a multilayer coating film using said aqueous primer composition is used for a plastic base material, it may not be possible to ensure sufficient adhesion to the plastic base material.

Meanwhile, with respect to a method for forming a coating film on a plastic base material, Japanese Patent Application Publication No. 2009-39668 (Patent Document 4), for example, discloses a method for forming a bright coating film, the method being characterized by using an aqueous primer coating composition that contains an aqueous non-chlorinated polyolefin-based resin, an aqueous polyurethane resin, an aqueous epoxy resin, an internally crosslinked acrylic particle emulsion and an emulsifying agent. However, in cases where this aqueous primer coating composition is used on an electrodeposition film formed on a steel sheet for a motor vehicle, it may not be possible to ensure sufficient strict quality requirements in terms of chipping resistance in low temperature environments.

### PRIOR ART DOCUMENTS

### Patent Literature

[Patent Document 1] Japanese Patent No. 5734920

[Patent Document 2] Japanese Patent Application Publication No. 2011-131135

[Patent Document 3] WO2011/010538

[Patent Document 4] Japanese Patent Application Publication No. 2009-39668

### SUMMARY OF INVENTION

### Problem to be Solved by the Invention

Therefore, a purpose of the present invention is to provide a method for forming a multilayer coating film by forming an aqueous primer coating film by coating the same specific aqueous primer coating composition on two coated objects, namely a metal base material and a plastic base material, and then coating the same aqueous first colored coating composition, the same aqueous second colored coating composition and the same clear coating composition in that order on the aqueous primer coating film using a wet-on-wet process, thereby enabling the formation of a coating film having an excellent appearance and excellent adhesion to the base material and chipping resistance even if the aqueous primer coating film is not pre-heated. Another purpose of the present invention is to provide a method for forming a multilayer coating film by which excellent coating film quality can be achieved even on a thin plastic base material.

### Means for Solving the Problem

As a result of diligent research into how to solve the problem mentioned above, the inventors of the present invention found that the problem mentioned above could be solved by using (1) an aqueous primer coating composition containing an aqueous polyolefin resin having a specific melting point and a specific molecular weight, an aqueous polyurethane resin having a specific glass transition temperature and a specific elongation percentage, a curing agent and electrically conductive carbon, (2) an aqueous first colored coating composition and an aqueous second colored coating composition, each of which contains, as a base resin, a core/shell emulsion in which the core substantially comprises an acrylic resin and the shell substantially comprises a polyurethane resin, and (3) a clear coating composition which contains a specific hydroxyl group-containing acrylic resin, a polyisocyanate compound and a melamine resin and which can form a clear coating film having a specific glass transition temperature and a specific elongation percentage, and thereby completed the present invention.

In cases where a thin plastic base material is used in order to reduce weight, there are concerns that low temperature impact resistance will deteriorate. In order for low temperature impact resistance not to deteriorate, it is effective to disperse stress generated by an impact in the second colored coating film and the clear coating film. By adding the melamine resin to the clear coating composition, and preferably to the aqueous second colored coating composition also, it is possible to control dispersion of stress in the second colored coating film and the clear coating film.

That is, the present invention relates to a method for forming a multilayer coating film, the method having a step of simultaneously coating the same aqueous primer composition on two objects to be coated, namely a pre-coated steel sheet and a pre-treated plastic base material for a motor vehicle, a step of simultaneously coating the same aqueous first colored coating composition on the primer-coated materials using a wet-on-wet process, a step of simultaneously coating the same aqueous second colored coating composition on the aqueous first colored coating composition-coated materials using a wet-on-wet process, a step of simultaneously coating the same clear coating composition on the aqueous second colored coating composition-coated materials, and a step of simultaneously curing the formed multilayer coating film, the method being characterized in that: the aqueous primer coating composition contains an aqueous polyolefin resin (A) having a melting point of 60° C. to 100° C. and a weight average molecular weight in the range of 50,000-250,000, an aqueous polyurethane resin (B) having a glass transition temperature (T_{g}) of −100° C. to −70° C. and an elongation percentage of 500% or more, a curing agent (C) and electrically conductive carbon (D), the aqueous first colored coating composition and aqueous second colored coating composition each contain a core/shell emulsion having an acrylic resin core and a polyurethane resin shell as a base resin, and the clear coating composition contains a hydroxyl group-containing acrylic resin, a polyisocyanate compound and a melamine resin.

Furthermore, the present invention relates to a method for forming a multilayer coating film, which is characterized in that the plastic base material contains a PP resin, an ABS resin, a PC resin or an ABS/PC resin.

Furthermore, the present invention relates to a method for forming a multilayer coating film, which is characterized in that the ratio in terms of parts by mass of component (A) and component (B) in the aqueous primer coating composition is 20/80 to 80/20 in terms of resin solid content, the ratio in terms of parts by mass of component (C) and {component (A)+component (B)} is 1/100 to 30/100 in terms of solid content, and furthermore the ratio in terms of parts by mass of component (D) and {component (A)+component (B)+component (C)} is 2/98 to 20/80 in terms of solid content.

Furthermore, the present invention relates to a method for forming a multilayer coating film, which is characterized in that component (B) in the aqueous primer coating composition is a colloidal dispersion type or emulsion type aqueous polyurethane resin.

Furthermore, the present invention relates to a method for forming a multilayer coating film, which is characterized in that component (B) in the aqueous primer coating composition is an aqueous polyurethane resin obtained by subjecting, if necessary, a polyurethane, which is obtained by reacting a polyisocyanate with a polyester polyol, a polycarbonate polyol or a polyether polyol, to chain extension using a low molecular weight compound having at least 2 active hydrogens in the molecule.

### Advantageous Effect of Invention

By using the method for forming a multilayer coating film of the present invention, it is possible to obtain a coating film having excellent appearance, chipping resistance and adhesion to objects to be coated, namely a steel sheet and a plastic base material, without pre-heating an aqueous primer coating film and/or an aqueous first colored coating film. In addition, it is possible to obtain a coating film having excellent low temperature impact resistance even on a thin plastic base material.

### MODE FOR CARRYING OUT THE INVENTION

The present invention will now be explained in greater detail, but is not limited to the specific examples.

### (1) Aqueous Primer Coating Composition

The aqueous primer coating composition used in the present invention contains (A) an aqueous polyolefin resin, (B) an aqueous polyurethane resin, (C) a curing agent and (D) electrically conductive carbon. Each component will now be explained.

### Aqueous Polyolefin Resin (A)

Component (A) is not particularly limited, with a wide range of polyolefin resins able to be used, but preferred polyolefin resins are polyolefin resins that do not contain chlorine. Here, a polyolefin resin that does not contain chlorine means a non-chlorinated polyolefin resin that is modified by an unsaturated carboxylic acid and/or anhydride.

Examples of polyolefin resins that do not contain chlorine include polyethylene resins, polypropylene resins and polybutene resins, but polypropylene resins are preferred. Examples of polypropylene resins include propylene homopolymer resins and copolymer resins of propylene and other α-olefins. Preferred examples of copolymer resins of propylene and other α-olefins include ethylene-propylene copolymer resins, propylene-butene copolymer resins, ethylene-propylene-butene copolymer resins and propylene-hexene copolymer resins. Of these, propylene-based polymer resins in which the propylene content is 50 mol % or more are more preferred, and propylene-based polymer resins in which the propylene content is 60 mol % or more are particularly preferred.

The unsaturated carboxylic acid or acid anhydride used for the modification is preferably an α,β-unsaturated carboxylic acid and/or an anhydride thereof, and specific examples thereof include maleic acid and the anhydride thereof, itaconic acid and the anhydride thereof and citraconic acid and the anhydride thereof, and one or more of these may be advantageously used. The degree of modification by the unsaturated carboxylic acid and/or anhydride is preferably 0.05-0.8 mmol, more preferably 0.07-0.5 mmol, and particularly preferably 0.1-0.35 mmol, relative to 1 g of the polyolefin resin that does not contain chlorine. This degree of modification (addition ratio can be measured by comparing the carbonyl group absorption intensity, as determined using infrared spectroscopy, with a calibration curve prepared using a sample for which the degree of modification (addition ratio is already known. Emulsification is difficult if this degree of modification is less than 0.05 mmol, and moisture resistance deteriorates if this degree of modification exceeds 0.8 mmol.

The polyolefin resin used in the present invention, which is preferably a non-chlorinated polyolefin resin such as those mentioned above, has a melting point of 60° C. to 100° C., and preferably 70° C. to 95° C. Moisture resistance deteriorates if the melting point is lower than 60° C., and adhesion, low temperature impact resistance and low temperature flexibility deteriorate if the melting point exceeds 100° C. Moreover, the melting point of the non-chlorinated polyolefin resin can be determined by measuring the quantity of heat absorbed when the temperature is increased from −80° C. to 120° C. at a rate of temperature increase of 5° C./min using a “DSC-50” differential scanning calorimeter (manufactured by Shimadzu Corp.). This melting point is the melting point prior to the aqueousification described below, and in cases where aqueousification is effected by, for example, bonding a hydrophilic polymer to a polyolefin resin, the melting point is the melting point of the polyolefin resin prior to bonding. That is, in the case of a graft copolymer with a hydrophilic polymer, the melting point is the melting point of the modified polyolefin resin that serves as the main resin.

In addition, the polyolefin resin used in the present invention, which is preferably a non-chlorinated polyolefin resin such as those mentioned above, has a weight average molecular weight of 50,000-250,000, and preferably 70,000-210,000. If the weight average molecular weight is less than 50,000, there are concerns that adhesion will deteriorate due to a reduction in cohesive strength of the coating film, and that gasohol resistance, moisture resistance and durability to vehicle jet washing will deteriorate. If the weight average molecular weight exceeds 250,000, aqueous resin production is impaired. Moreover, in the present invention, weight average molecular weight means the value obtained when the weight average molecular weight, as determined by means of gel permeation chromatography (GPC) at a temperature of 40° C. and a flow rate of 1 ml/min with tetrahydrofuran (THF) as an eluent, is determined on the basis of the weight average molecular weight of polystyrene. TSKgel G2000H_{XL}, G3000H_{XL}, G4000H_{XL}, G5000H_{XL} (manufactured by Tosoh Corp.) are used as columns for the gel permeation chromatography (GPC). This weight average molecular weight is the molecular weight prior to the aqueousification described below, and in cases where aqueousification is effected by, for example, bonding a hydrophilic polymer to a polyolefin resin, the weight average molecular weight is the weight average molecular weight of the polyolefin resin prior to bonding. That is, in the case of a graft copolymer of the polyolefin resin and a hydrophilic polymer, the weight average molecular weight is the weight average molecular weight of the modified polyolefin resin that serves as the main resin.

The polyolefin resin used in the present invention, which is preferably a non-chlorinated polyolefin resin such as those mentioned above, is preferably one that is aqueousified (hydrophilized) when dispersed in an aqueous medium.

In order to aqueousify the polyolefin resin, and especially a non-chlorinated polyolefin resin such as those mentioned above, it is possible to effect aqueousification by reacting with ammonia or an amine-based compound, such as a primary to tertiary organic amine, so as to form a salt. The amine-based compound can be a tertiary amine compound such as triethylamine, tripropylamine, tributylamine, dimethylethanolamine, triethanolamine or pyridine; a secondary amine compound such as dipropylamine, dibutylamine, diethanolamine or piperidine; or a primary amine compound such as propylamine, butylamine, ethanolamine or aniline, but a tertiary amine is particularly preferred.

The usage quantity of ammonia or amine-based compound is 0.5-3.0 moles, and preferably 0.8-2.5 moles, relative to 1 mole of carboxyl groups in the polyolefin resin being aqueousified.

In addition, a surfactant may, if necessary, be used in order to aqueousify a polyolefin resin such as those mentioned above. Surfactants able to be used include nonionic surfactants such as polyoxyethylene monoalkyl ethers, polyoxyethylene monoalkyl aryl ethers and polyoxyethylene monoalkyl esters; and anionic surfactants such as polyoxyethylene alkyl aryl sulfate salts, alkyl aryl sulfate salts and alkyl sulfate salts. It is generally preferable for the usage quantity of the surfactant to be 10 mass % or less relative to the quantity of solid content in the non-chlorinated polyolefin resin.

In addition, a polyolefin resin such as those mentioned above may be aqueousified using a method comprising bonding a non-chlorinated polyolefin resin, which is modified by means of an unsaturated carboxylic acid and/or anhydride, to a hydrophilic polymer such as a poly(oxyethylene/oxypropylene) block copolymer. The weight average molecular weight of the hydrophilic polymer is preferably 200-100,000, more preferably 300-50,000, and further preferably 500-10,000. In addition, the degree of bonding of the hydrophilic polymer to the non-chlorinated polyolefin resin, which is modified by means of an unsaturated carboxylic acid and/or anhydride, is preferably 0.05-1.0 mmol, and particularly preferably 0.1-0.6 mmol, relative to 1 g of the modified non-chlorinated polyolefin resin. This method can be a publicly known method, such as that disclosed in Japanese Patent Application Publication No. 2008-031360.

The aqueous polyolefin resin of component (A) is preferably such that a non-chlorinated polyolefin resin, and more preferably an aqueousified non-chlorinated polyolefin resin, is dispersed in an aqueous medium. It is generally preferable for the concentration of dispersed polyolefin resin in the aqueous polyolefin resin dispersion to be 5-50 mass %, and more preferably 10-40 mass %.

Moreover, it is possible to blend another solvent other than water in the aqueous medium. Examples of other solvents include aromatic hydrocarbons such as toluene and xylene; aliphatic hydrocarbons such as hexane, octane and decane; alicyclic hydrocarbons such as cyclohexane and methylcyclohexane; halogenated hydrocarbons such as methylene chloride, carbon tetrachloride and chlorobenzene; esters such as methyl acetate, ethyl acetate, propyl acetate and butyl acetate; ketones such as acetone, methyl ethyl ketone, methyl propyl ketone, methyl isobutyl ketone and cyclohexanone; alcohols such as methanol, ethanol, n-propanol, isopropanol, n-butanol, 2-butanol, isobutanol, t-butanol, cyclohexanol, ethylene glycol, propylene glycol and butane diol; ethers such as dipropyl ether, dibutyl ether and tetrahydrofuran; organic solvents having 2 or more functional groups, such as 2-methoxyethanol, 2-ethoxyethanol, 2-butoxyethanol, 2-methoxypropanol, 2-ethoxypropanol and diacetone alcohol; and polar solvents such as dimethylformamide and dimethyl sulfoxide. It is possible to use only one of these solvents, or a combination of two or more types thereof.

Of these, a solvent having a solubility in water of 1 mass % or more is preferred, and a solvent having a solubility in water of 5 mass % or more is more preferred, with methyl ethyl ketone, methyl propyl ketone, cyclohexanone, n-propanol, isopropanol, n-butanol, 2-butanol, isobutanol, t-butanol, cyclohexanol, tetrahydrofuran, 2-methoxyethanol, 2-ethoxyethanol, 2-butoxyethanol, 2-methoxypropanol, 2-ethoxypropanol and diacetone alcohol being preferred.

### Aqueous Polyurethane Resin (B)

The aqueous polyurethane resin that is component (B) can be a hydrophilized urethane resin obtained by neutralizing a urethane prepolymer, which is obtained by reacting a polyfunctional isocyanate compound, a polyol having 2 or more hydroxyl groups per molecule and a hydroxyl group-containing compound having an anionic group, with one or more neutralizing agents selected from among ammonia, organic amine compounds and inorganic salts (potassium hydroxide, sodium hydroxide, or the like). Furthermore, it is possible to use a resin obtained by increasing the molecular weight of an aqueous hydrophilized urethane resin dispersion using a low molecular weight compound (a chain extender) having an active hydrogen, such as water, a water soluble polyamine or a glycol compound. In addition, the urethane resin may, if necessary, be modified by an acrylic compound or the like.

The type of polyol used in this polyurethane resin is not particularly limited, and it is possible to use one or more polyester polyols, polyether polyols, polycarbonate polyols, and the like, and the urethane prepolymer obtained using these polyols may be partially modified by an acrylic resin. In addition, it is possible to use an inorganic base such as potassium hydroxide or sodium hydroxide, as mentioned above, when hydrophilizinging the urethane prepolymer, but ammonia and organic amine compounds, which have low boiling points and readily evaporate, are preferred from the perspective of moisture resistance.

In cases where the polyurethane resin contains hydroxyl groups, unreacted hydroxyl groups remain in the coating film and cause a decrease in moisture resistance, which is not desirable.

The aqueous polyurethane resin may be water-soluble, but is preferably a colloidal dispersion type or emulsion dispersion type resin, for example, a type in which dispersed colloids or micelle colloids are formed by being dispersed in the form of particles in water. It is preferable for the aqueous polyurethane resin dispersion to have a measurable particle diameter and for the average particle diameter to be 130 nm or less. In the case of a water-soluble polyurethane resin which dissolves in water so that particle diameters cannot be measured, sagging readily occurs during coating and the appearance of the coating film deteriorates, which is not desirable.

In cases where the average particle diameter of the aqueous polyurethane resin dispersion exceeds 130 nm, particles settle due to being large, the viscosity of the coating composition increases, and coating defects such as seeding readily occur, which is not desirable. The upper limit of the average particle diameter of the aqueous polyurethane resin dispersion is preferably 120 nm or less, and more preferably 100 nm or less. The lower limit of the average particle diameter of the aqueous polyurethane resin dispersion is not particularly limited, but is preferably 5 nm or more, and more preferably 10 nm or more.

The particle diameter of the aqueous polyurethane resin dispersion is measured using a Nicomp 380ZLS particle size distribution/zeta potential measurement device manufactured by Nicomp, and uses Gaussian distribution/volume weighting values.

It is generally preferable for the concentration of dispersed polyurethane resin in the aqueous polyurethane resin dispersion to be 5-50 mass %, and more preferably 10-40 mass %.

In addition, one or more solvents such as N-methyl-2-pyrrolidone, N-ethyl-2-pyrrolidone or 2-butoxyethanol may, if necessary, be incorporated in the aqueous medium of the aqueous polyurethane resin dispersion.

A publicly known method such as that disclosed in Japanese Patent Application Publication No. 2008-056914 is known as a specific example of a method for producing the aqueous polyurethane resin dispersion that is component (B). Examples of commercially available aqueous polyurethane resin dispersions include Bayhydrol VP LS2952/1 and Bayhydrol 2342 (manufactured by Sumika Bayer Urethane Co., Ltd.).

The glass transition temperature of the aqueous polyurethane resin that is component (B) is preferably −100° C. to −70° C., and more preferably −100° C. to −90° C. A deterioration in adhesive properties and moisture resistance caused by a decrease in cohesive strength of the coating film may occur in cases where the glass transition temperature is lower than −100° C., and a deterioration in chipping resistance caused by insufficient coating film flexibility may occur in cases where the glass transition temperature is higher than −70° C.

Moreover, the glass transition temperature of the aqueous polyurethane resin is a value obtained by placing a dispersion liquid, which is obtained by dispersing the aqueous polyurethane resin in an aqueous medium, in a polypropylene tray in the manner such that the dry film thickness is 15 μm, drying at room temperature so as to prepare an aqueous polyurethane resin sheet, completely eliminating moisture at a temperature of 110° C., and then measuring the glass transition temperature by using a “DSC-50” differential scanning calorimeter (manufactured by Shimadzu Corp.) in the range of from −140° C. to 60° C. at a rate of temperature increase of 5° C./min. The glass transition temperature mentioned in the present specification is a transition initiation temperatures in the DSC (differential scanning calorimetry).

In addition, it is preferable for a coating film formed from the aqueous polyurethane resin that is component (B) to have an elongation percentage of 500% or more at −20° C. If the elongation percentage of the coating film is less than 500%, the flexibility of the coating film deteriorates and chipping resistance may deteriorate.

Moreover, the elongation percentage of a coating film of the aqueous polyurethane resin is a value obtained by placing a dispersion liquid, which is obtained by dispersing the aqueous polyurethane resin in an aqueous medium, in a polypropylene tray in the manner such that the dry film thickness is 15 μm, drying at room temperature so as to prepare an aqueous polyurethane resin sheet, completely eliminating moisture at a temperature of 110° C., preparing a strip-shaped measurement sample (10×70 mm) from the sheet, and then measuring the elongation percentage using a “TENSILON UTM type III” tensile tester (manufactured by A&D Co. Ltd.).

The measurement is carried out at a temperature of −20′ C and a pulling rate of 4 mm/min with a measurement length of 40 mm. The elongation percentage is the average value in 5 measurements.

### Curing Agent (C)

Examples of the curing agent that is component (C) include amino resins and blocked polyisocyanate compounds. It is possible to use one of these curing agents in isolation, or a combination of two or more types thereof.

“Amino resin” is a general term for resins obtained by adding and condensing formaldehyde with amino group-containing compounds, and more specifically, it is possible to select one or more types from among melamine resins, urea resins, guanamine resins, and the like. Of these, melamine resins are preferred. Furthermore, it is possible to use an alkyl ether-modified amino resin obtained by etherifying some or all of the methylol groups in the amino resin with one or more types of alcohol selected from among monohydric alcohols such as methanol, ethanol, propanol and butanol.

Examples of blocked polyisocyanate compounds include compounds obtained by blocking isocyanate groups in polyisocyanate compounds with, for example, an alcohol such as butanol; an oxime compound such as methyl ethyl ketooxime; a lactam compound such as ϵ-caprolactam; a diester such as an acetoacetic acid ester; an imidazole compound such as imidazole or 2-ethylimidazole; and a phenol compound such as m-cresol.

The polyisocyanate compound can be one or more compounds selected from among, for example, aliphatic diisocyanates such as hexamethylene diisocyanate, trimethylhexamethylene diisocyanate and dimer acid diisocyanates; cyclic aliphatic diisocyanates such as isophorone diisocyanate, xylylene diisocyanate (XDI), meta-xylylene diisocyanate and hydrogenated XDI; aromatic diisocyanates such as tolylene diisocyanate (TDI), 4,4-diphenylmethane diisocyanate (MDI), hydrogenated TDI and hydrogenated MDI; and adducts, biurets and isocyanurates of these.

### Electrically Conductive Carbon (D)

An example of the electrically conductive carbon that is component (D) is carbon black. It is preferable for the electrically conductive carbon to have a specific surface area of, for example, 200 m²/g or more, and more preferably 800 m²/g or more. In cases where the specific surface area is less than 200 m²/g, the number of particles per unit weight of carbon black decreases and electrical conductivity decreases, which is not desirable. The average particle diameter of the electrically conductive carbon is preferably 10-50 nm.

In the aqueous primer coating composition used in the present invention, the mass ratio of the polyolefin resin that is component (A) relative to the polyurethane resin that is component (B), that is, the mass ratio represented by (A)/(B), is preferably in the range of 20/80 to 80/20, more preferably in the range of 20/80 to 60/40, and particularly preferably in the range of 20/80 to 40/60, in terms of solid content. Moreover, in cases where component (A) is aqueousified, the solid content value used to calculate the mass ratio of component (A) is the value following aqueousification.

In cases where the mass ratio of component (A) relative to component (B) is lower than 20/80, adhesion to polypropylene base materials decreases. In addition, in cases where the mass ratio of component (A) relative to component (B) is higher than 80/20, defects occur in terms of adhesion to the aqueous first colored coating film due to differences in polarity.

In addition, the mass ratio of component (C) relative to the total of component (A) and component (B), that is, the mass ratio represented by (C)/{(A)+(B)}, is in the range of 1/100 to 30/100, and preferably in the range of 5/100 to 25/100, in terms of solid content. If the mass ratio of component (C) relative to the total of component (A) and component (B) is lower than 1/100, adhesion, moisture resistance, water resistance and chipping resistance may deteriorate due to insufficient curing. In addition, if the mass ratio of component (C) relative to the total of component (A) and component (B) is higher than 30/100, moisture resistance, water resistance and chipping resistance may deteriorate due to an excess of curing agent.

In addition, the mass ratio of the electrically conductive carbon of component (D) relative to the total of component (A), component (B) and component (C), that is, the mass ratio represented by (D)/{(A)+(B)+(C)}, is in the range of 2/98 to 20/80, preferably in the range of 4/96 to 17/83, and particularly preferably in the range of 6/94-15/85, in terms of solid content.

Electrical conductivity decreases if the mass ratio of component (D) relative to the total of component (A), component (B) and component (C) is lower than 2/98, and dispersion defects occur and coating defects such as sedimentation and seeding may occur if the mass ratio of component (D) relative to the total of component (A), component (B) and component (C) is higher than 20/80.

Components commonly used according to need in the technical field of coating materials, such as coloring pigments, body pigments, anti-foaming agents, rheology-controlling agents, pigment dispersing agents, curing catalysts and organic solvents, can be used as appropriate in the aqueous primer coating composition used in the present invention. Examples of coloring pigments include titanium dioxide, red iron oxide, azo pigments and phthalocyanine pigments, and examples of body pigments include talc, silica, calcium carbonate, barium sulfate and hydrozincite (zinc oxide).

The aqueous primer coating composition used in the present invention contains the components mentioned above and an aqueous medium, but the overall content of these components is preferably 15-45 mass %, and more preferably 25-40 mass %, in terms of solid content.

By using an aqueous primer coating composition such as that described above, it is possible to achieve excellent chipping resistance and excellent adhesion to plastic base materials.

### (2) Aqueous First Colored Coating Composition and Aqueous Second Colored Coating Composition

The aqueous first colored coating composition and the aqueous second colored coating composition used in the present invention each contain, as a base resin, a core/shell emulsion in which the core contains an acrylic resin as the primary component and the shell contains a polyurethane resin as the primary component. The core and shell may contain components other than the resins (the acrylic resin and polyurethane resin) that serve as the primary components, but it is preferable for the core to be constituted essentially from an acrylic resin and for the shell to be constituted essentially from a polyurethane resin. The core/shell emulsion is obtained by synthesizing the acrylic resin that serves as the core in an aqueous solution or aqueous dispersion of the polyurethane resin that serves as the shell. Here, because the polyurethane resin has hydrophilic groups and the acrylic resin does not have hydrophilic groups, when these resins form micelles in water, the polyurethane resin acts as an emulsifying agent and is positioned at the outside of the micelles, the acrylic resin is positioned on the inside of the micelles, and these resins form a core/shell structure. Moreover, a “core/shell structure” means a structure in which two types of resin component having different resin compositions are present inside the same micelle, one of the resin components forms a central portion (the core) and the other resin component forms an outer shell portion (the shell).

### Polyurethane Resin (Shell)

The polyurethane resin that serves as the shell of the core/shell emulsion resin can be obtained using a publicly known method in which a polyol, a polyisocyanate compound, a dimethylol alkanoic acid, a polyhydric alcohol, and the like, are used as raw material components, but an example thereof is a method such as that explained below. A polyurethane resin having a terminal hydroxyl group can be ultimately obtained by first synthesizing a polyol resin and then obtaining a urethane prepolymer from this polyol resin.

The polyol resin can be one or more types selected from among a polyester resin, a polyether resin, a polycarbonate polyol resin, or the like, but from the perspective of chipping resistance, a polyester resin is preferred.

The polyester resin can be obtained using a publicly known method in which an esterification reaction is carried out using a polybasic acid and a polyhydric alcohol as raw material components.

This polybasic acid can generally be a polycarboxylic acid, but it is possible to additionally use a monobasic fatty acid or the like if necessary. Examples of polycarboxylic acids include phthalic acid, isophthalic acid, tetrahydrophthalic acid, tetrahydroisophthalic acid, hexahydrophthalic acid, hexahydroisophthalic acid, trimellitic acid, adipic acid, sebacic acid, succinic acid, azelaic acid, fumaric acid, maleic acid, itaconic acid, pyromellitic acid, and acid anhydrides thereof. It is possible to use one of these polybasic acids in isolation, or a combination of two or more types thereof.

Examples of this polyhydric alcohol include glycols and trihydric or higher polyhydric alcohols. Examples of glycols include ethylene glycol, propylene glycol, diethylene glycol, triethylene glycol, tetraethylene glycol, dipropylene glycol, polyethylene glycol, polypropylene glycol, neopentyl glycol, hexylene glycol, 1,3-butane diol, 1,4-butane diol, 1,5-pentane diol, 1,6-hexane diol, 2-butyl-2-ethyl-1,3-propane diol, methylpropane diol, cyclohexane dimethanol and 3,3-diethyl-1,5-pentane diol. In addition, examples of trihydric or higher polyhydric alcohols include glycerin, trimethylolethane, trimethylolpropane, pentaerythritol and dipentaerythritol. It is possible to use one of these polyhydric alcohols in isolation, or a combination of two or more types thereof.

The abovementioned polyol resin (segment resin) that serves as a segment is not particularly limited, but a segment resin having a number average molecular weight of 1,000-5,000 is preferred, and preferred specific examples of this number average molecular weight include 1,000, 1,500, 2,000, 2,500, 3,000, 3,500, 4,000, 4,500 and 5,000, and it is possible to use a number average molecular weight range that falls between two of the numerical values listed here.

Next, a urethane prepolymer having a terminal isocyanate group is obtained by reacting the thus obtained segment resin with a carboxyl group-containing diol and a polyisocyanate compound. Examples of the carboxyl group-containing diol that reacts with the segment resin include dimethylolpropionic acid, dimethylolbutanoic acid, dimethylolpentanoic acid, dimethylolheptanoic acid, dimethyloloctanoic acid and dimethylolnonanoic acid. Of these, dimethylolpropionic acid and dimethylolbutanoic acid are preferred from perspectives such as being able to obtain an excellent coating film and manufacturing costs. It is possible to use one of these carboxyl group-containing diols in isolation, or a combination of two or more types thereof.

In addition, examples of the polyisocyanate compound that reacts with the segment resin include aromatic diisocyanates such as 4,4′-diphenylmethane diisocyanate, 2,4- or 2,6-tolylene diisocyanate, 1,5-naphthalene diisocyanate and p- or m-phenylene diisocyanate; alicyclic diisocyanates such as isophorone diisocyanate, 4,4′-dicyclohexylmethane diisocyanate, 1,4-cyclohexylene diisocyanate and hydrogenated tolylene diisocyanate; aliphatic diisocyanates such as hexamethylene diisocyanate; xylylene diisocyanate and m-tetramethylxylylene diisocyanate. Of these, alicyclic diisocyanates are preferred from perspectives such as yellowing resistance. It is possible to use one of these polyisocyanate compounds in isolation, or a combination of two or more types thereof.

Finally, a polyurethane resin having a terminal hydroxyl group is obtained by reacting the thus obtained urethane prepolymer with a polyhydric alcohol.

Examples of the polyhydric alcohol that reacts with the urethane prepolymer include ethylene glycol, propylene glycol, 1,3-butylene glycol, 1,4-butane diol, 1,6-hexane diol, diethylene glycol, dipropylene glycol, neopentyl glycol, triethylene glycol, hydrogenated bisphenol A, glycerin, trimethylolethane, trimethylolpropane, pentaerythritol and dipentaerythritol. It is possible to use one of these polyhydric alcohols in isolation, or a combination of two or more types thereof.

By introducing a specific proportion of a dibasic acid and/or dihydric alcohol having 10-60 carbon atoms into the polyurethane resin, it is possible to obtain a coating film having an excellent appearance. A dibasic acid and/or dihydric alcohol having 10-60 carbon atoms may be introduced into the abovementioned segment resin or into another portion, but by using a dibasic acid and/or dihydric alcohol having 10-60 carbon atoms as a raw material for synthesizing the segment resin, it is possible to obtain a coating film having a significantly better appearance.

From the perspective of coating appearance, the number of carbon atoms in the dibasic acid and/or dihydric alcohol is preferably 30-40, and more preferably 34-38. If the number of carbon atoms in the dibasic acid and/or dihydric alcohol is less than 10, the polarity of the polyurethane resin of the shell increases, meaning that the aqueous first colored coating composition and the aqueous second colored coating composition undergo layer mixing and coating film appearance may deteriorate, and if the number of carbon atoms in the dibasic acid and/or dihydric alcohol is greater than 60, the water solubility of the polyurethane resin of the shell decreases, meaning that the acrylic resin that should form the core and the polyurethane resin that should form the shell cannot form a core/shell structure.

Examples of dibasic acids having 10-60 carbon atoms include sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,15-pentadecanedicarboxylic acid, 1,16-hexadecanedicarboxylic acid, 2-hexadecylmalonic acid, 1,18-octadecanedicarboxylic acid, dimer acids and hydrogenated dimer acids. Of these, dimer acids are preferred from the perspective of being able to achieve better coating film appearance. It is possible to use one of these dibasic acids having 10-60 carbon atoms in isolation, or a combination of two or more types thereof.

Examples of dihydric alcohols having 10-60 carbon atoms include 1,10-decane diol, 1,2-decane diol, 3,6-dimethyl-3,6-octane diol, 2,2-dibutylpropane-1,3-diol, 1,12-dodecane diol, 1,2-dodecane diol, 1,13-tridecane diol, 2,2-diisoamyl-1,3-propane diol, 1,14-tetradecane diol, 1,2-tetradecane diol, 1,15-pentadecane diol, 1,16-hexadecane diol, 1,2-hexadecane diol, 1,2-heptadecane diol, 1,12-octadecane diol, 2,2-di-n-octyl-1,3-propane diol, 1,20-eicosane diol and dimer diols. Of these, dimer diols are preferred from the perspective of being able to achieve better coating film appearance. It is possible to use one of these dihydric alcohols having 10-60 carbon atoms in isolation, or a combination of two or more types thereof.

The overall mass ratio of constituent units derived from dibasic acids and/or dihydric alcohols having 10-60 carbon atoms is 10-50 mass % relative to solid resin content in the polyurethane resin that serves as the shell and from the perspective of coating film appearance, is preferably 20-40 mass %, and more preferably 30-35 mass %. If the overall mass ratio of dibasic acids and/or dihydric alcohols is less than 10 mass %, the polarity of the polyurethane resin increases, meaning that the aqueous first colored coating composition and the aqueous second colored coating composition undergo layer mixing, and coating film appearance may deteriorate, and if the overall mass ratio of dibasic acids and/or dihydric alcohols is greater than 50 mass %, drying properties become too high, meaning that sufficient flow properties cannot be achieved and coating film appearance may deteriorate.

The polyurethane resin that serves as the shell has a sufficient amount of hydrophilic groups for forming an aqueous solution or aqueous dispersion and has functional groups for reacting with the curing agent. Specific examples of these hydrophilic groups include carboxyl groups, amino groups and methylol groups.

The hydroxyl value of the polyurethane resin that serves as the shell is 20-80 mg KOH/g, and is preferably 30-70 mg KOH/g, and more preferably 35-45 mg KOH/g, from the perspective of adhesion to an object to be coated. Adhesion to an object to be coated may deteriorate if the hydroxyl value is less than 20 mg KOH/g, and if the hydroxyl value exceeds 80 mg KOH/g, the polarity of the polyurethane resin increases, the aqueous first colored coating composition and the aqueous second colored coating composition undergo layer mixing, and coating film appearance may deteriorate.

In addition, the acid value of the polyurethane resin that serves as the shell is 10-60 mg KOH/g, and is preferably 30-40 mg KOH/g from the perspective of coating film appearance. If the acid value is less than 10 mg KOH/g, the emulsion stability of the polyurethane resin in the aqueous medium deteriorates, meaning that coating film appearance may deteriorate, and if the acid value exceeds 60 mg KOH/g, the water solubility of the polyurethane resin becomes too high, meaning that the aqueous first colored coating composition and the aqueous second colored coating composition undergo layer mixing, and coating film appearance may deteriorate.

The number average molecular weight of the polyurethane resin that serves as the shell is not particularly limited, but is, for example, 500-50,000, and specific examples of this number average molecular weight include 500, 1,500, 2,500, 3,500, 4,500, 5,500, 6,500, 7,500, 10,000, 15,000, 20,000, 30,000, 40,000 and 50,000, and it is possible to use a number average molecular weight range that falls between two of the numerical values listed here. Moreover, in the present specification, the number average molecular weight is a value obtained by means of gel permeation chromatography (GPC) using polystyrene as a standard substance.

Acrylic resin (core)

The acrylic resin that serves as the core can be obtained using a publicly known method that uses a radical polymerization reaction using a radical-polymerizable monomer as a raw material component, and is synthesized in an aqueous solution or aqueous dispersion of the polyurethane resin that serves as the shell.

Examples of radical-polymerizable monomers include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, hexyl (meth)acrylate, cyclohexyl (meth)acrylate, 2-ethylhexyl (meth)acrylate, octyl (meth)acrylate, lauryl (meth)acrylate, stearyl (meth)acrylate, allyl alcohol, 2-hydroxyethyl (meth) acrylate, 3-hydroxypropyl (meth)acrylate, 4-hydroxybutyl (meth)acrylate, styrene, (meth)acrylonitrile and (meth)acrylamide. It is possible to use one of these radical-polymerizable monomers in isolation, or a combination of two or more types thereof.

It is possible to blend a radical polymerization initiator when synthesizing the acrylic resin. Examples of radical polymerization initiators include azo compounds such as 2,2′-azobisisobutyronitrile, 2,2′-azobis-2,4-dimethylvaleronitrile, 4,4′-azobis-4-cyanovaleric acid, 1-azobis-1-cyclohexanecarbonitrile and dimethyl-2,2′-azobisisobutyrate; and organic peroxides such as methyl ethyl ketone peroxide, cyclohexanone peroxide, 3,5,5-trimethylhexanone peroxide, 1,1-bis(t-butylperoxy)-3,3,5-trimethylcyclohexane, 1,1-bis(t-butylperoxy)-cyclohexane, 2,2-bis(t-butylperoxy)octane, t-butyl hydroperoxide, diisopropylbenzene hydroperoxide, dicumyl peroxide, t-butylcumyl peroxide, isobutyl peroxide, lauroyl peroxide, benzoyl peroxide, diisopropyl peroxydicarbonate, t-butylperoxy 2-ethylhexanoate, t-butylperoxy neodecanate, t-butylperoxy laurate, t-butylperoxy benzoate and t-butylperoxy isopropyl carbonate. It is possible to use one of these radical polymerization initiators in isolation, or a combination of two or more types thereof.

The hydroxyl value of the acrylic resin that serves as the core is 40-140 mg KOH/g, and is preferably 60-120 mg KOH/g, and more preferably 75-85 mg KOH/g, from the perspectives of coating film appearance and adhesion to an object to be coated. Adhesion to an object to be coated may deteriorate if the hydroxyl value is less than 40 mg KOH/g, and if the hydroxyl value exceeds 140 mg KOH/g, the polarity of the core becomes too high, meaning that the acrylic resin that should form the core and the polyurethane resin that should form the shell do not form a core/shell structure, and coating film appearance may deteriorate.

The acid value of the acrylic resin that serves as the core is 0-10 mg KOH/g, and is preferably 0-5 mg KOH/g, and more preferably 0-3 mg KOH/g, from the perspective of coating film appearance. If the acid value exceeds 10 mg KOH/g, the acrylic resin that should form the core and the polyurethane resin that should form the shell may not form a core/shell structure.

The glass transition temperature (Tg) of the acrylic resin that serves as the core is not particularly limited, but is, for example, 20° C. to 60° C., and specific examples of this glass transition temperature include 20° C., 25° C., 30° C., 35° C., 40° C., 45° C., 50° C., 55° C. and 60° C., and it is possible to use a glass transition temperature range that falls between two of the numerical values listed here.

Because the acrylic resin that serves as the core is synthesized in an aqueous solution or aqueous dispersion of the polyurethane resin that serves as the shell, it is difficult to accurately measure the number average molecular weight of the acrylic resin. The number average molecular weight of the acrylic resin varies mainly according to the reaction temperature during the synthesis and the quantity of radical polymerization initiator used for the synthesis. The reaction temperature during the synthesis is, for example, 60° C. to 110° C., and specific examples thereof include 60° C., 70° C., 80° C., 90° C., 100° C. and 110° C., and it is possible to use a reaction temperature range that falls between two of the numerical values listed here. In addition, the quantity of radical polymerization initiator used for the synthesis is 0.1-3.0 parts by mass relative to 100 parts by mass of the radical polymerizable monomer, and specific examples thereof include 0.1, 0.5, 1.0, 1.5, 2.0, 2.5 and 3.0 parts by mass, and it is possible to use a quantity range that falls between two of the numerical values listed here.

In the core/shell emulsion resin contained in the aqueous first colored coating composition and the aqueous second colored coating composition, the mass ratio of the core and the shell is 20/80 to 80/20, and is preferably 35/65 to 65/35, and more preferably 45/55 to 55/45, from the perspective of coating film appearance. If the mass proportion of the core is less than 20 parts by mass relative to 80 parts by mass of the shell, the water solubility of the core/shell emulsion resin increases, the aqueous first colored coating composition and the aqueous second colored coating composition undergo layer mixing, and coating film appearance may deteriorate. Meanwhile, if the mass proportion of the core exceeds 80 parts by mass relative to 20 parts by mass of the shell, the particulate nature of the acrylic resin of the core becomes stronger, meaning that coating film appearance may deteriorate.

In order to stabilize the core/shell emulsion resin in the aqueous first colored coating composition and the aqueous second colored coating composition, it is preferable to neutralize some or all of the carboxyl groups in the core/shell emulsion resin by means of a basic substance so as to impart self-emulsifying properties. Examples of the basic substance used for the neutralization include ammonia, morpholine, N-alkylmorpholine compounds, monoisopropanolamine, methylethanolamine, methylisopropanolamine, dimethylethanolamine, diisopropanolamine, diethanolamine, triethanolamine, diethylethanolamine, triethanolamine, methylamine, ethylamine, propylamine, butylamine, 2-ethylhexylamine, dimethylamine, diethylamine, dipropylamine, dibutylamine, trimethylamine, triethylamine, triisopropylamine and tributylamine. It is possible to use one of these basic substances in isolation, or a combination of 2 or more types thereof.

In the aqueous colored coating compositions, the mass ratio of the core/shell emulsion resin relative to the total quantity of solid resin content in the base resin is preferably 5-80 mass %, and more preferably 10-40 mass %, from the perspective of coating film appearance.

In addition to the core/shell emulsion resin, it is preferable for the aqueous colored coating compositions to contain a publicly known aqueous resin as a base resin. At least one type selected from among polyurethane resins and acrylic resins is preferred as the publicly known aqueous resin.

It is preferable for the aqueous polyurethane resin to have a hydroxyl value of, for example, 10-140 mg KOH/g and an acid value of, for example, 3-80 mg KOH/g.

It is preferable for the number average molecular weight of the aqueous polyurethane resin to be, for example, 1,000-100,000. Specific examples of this number average molecular weight include 1,000, 5,000, 10,000, 20,000, 40,000, 60,000, 80,000 and 100,000, and it is possible to use a number average molecular weight range that falls between two of the numerical values listed here.

It is preferable for the aqueous acrylic resin to have a hydroxyl value of, for example, 10-200 mg KOH/g, an acid value of, for example, 0-20 mg KOH/g and a glass transition temperature of, for example, −40° C. to 80° C. Moreover, glass transition temperatures mentioned in the present specification are transition initiation temperatures in DSC (differential scanning calorimetry).

It is preferable for the number average molecular weight of the aqueous acrylic resin to be, for example, 1,000-1,000,000. Specific examples of this number average molecular weight include 1,000, 5,000, 10,000, 50,000, 100,000, 200,000, 400,000, 600,000, 800,000 and 1,000,000, and it is possible to use a number average molecular weight range that falls between two of the numerical values listed here.

It is possible to incorporate a variety of pigments, such as coloring pigments, glittery pigments and body pigments, in the aqueous colored coating compositions. Examples of coloring pigments include inorganic pigments such as chrome yellow, yellow iron oxide, iron oxide, carbon black and titanium dioxide; and organic pigments such as azo chelate pigments, insoluble azo pigments, condensed azo pigments, phthalocyanine pigments, indigo pigments, perynone pigments, perylene pigments, dioxane pigments, quinacridone pigments, isoindolinone pigments and metal complex pigments. In addition, examples of glittery pigments include aluminum flake pigments, alumina flake pigments, mica pigments, silica flake pigments and glass flake pigments. In addition, examples of body pigments include calcium carbonate, baryte, precipitated barium sulfate, clay and talc. It is possible to use one of these pigments in isolation, or a combination of 2 or more types thereof.

In cases where a pigment is added to an aqueous colored coating composition, the mass ratio of the pigment is 3-200 mass % relative to the total quantity (100 mass %) of solid resin content in the base resin, and specific examples of this mass ratio include 3, 5, 15, 30, 50, 70, 90, 110, 130, 150, 175 and 200 mass %, and it is possible to use a mass ratio range that falls between two of the numerical values listed here.

One or more types of additive such as surface modifiers, anti-foaming agents, surfactants, auxiliary film-forming agents, preservatives, ultraviolet radiation absorbers, photostabilizers and antioxidants, rheology control agents, and organic solvents may be incorporated in the aqueous colored coating compositions.

The aqueous colored coating compositions contain water as a medium, but the aqueous colored coating compositions may, if necessary, be coated after being diluted to an appropriate viscosity by using more water or, according to circumstances, a small quantity of an organic solvent or an amine.

In the method for forming a multilayer coating film of the present invention, in cases where aqueous colored coating compositions such as those mentioned above are used as the aqueous first colored coating composition and the aqueous second colored coating composition, it is possible to ensure adhesion to an object to be coated even if the aqueous second colored coating composition does not contain a curing agent.

Examples of the curing agent for the aqueous first colored coating composition include amino resins, polyisocyanate compounds, blocked polyisocyanate compounds and polycarbodiimide compounds. Of these, polyisocyanate compounds and polycarbodiimide compounds are preferred from the perspective of coating film appearance. In addition, it is possible to use one of these curing agents in isolation, or a combination of two or more types thereof.

“Amino resin” is a general term for resins obtained by adding and condensing formaldehyde with amino group-containing compounds, and more specifically, it is possible to use a melamine resin, a urea resin, a guanamine resin, or the like. Of these, a melamine resin is preferred. Furthermore, it is possible to use an alkyl ether-modified amino resin obtained by etherifying some or all of the methylol groups in the amino resin with one or more types of alcohol selected from among monohydric alcohols such as methanol, ethanol, propanol and butanol.

In cases where an amino resin is used as the curing agent, the solid content mass ratio expressed by (base resin/amino resin) is preferably 1.0-4.0, and more preferably 1.8-3.0, from the perspectives of adhesion to an object to be coated, water resistance and chipping resistance.

The polyisocyanate compound can be, for example, an aliphatic diisocyanate such as hexamethylene diisocyanate, trimethylhexamethylene diisocyanate or a dimer acid diisocyanate; a cyclic aliphatic diisocyanate such as isophorone diisocyanate, xylylene diisocyanate (XDI), meta-xylylene diisocyanate or hydrogenated XDI; an aromatic diisocyanate such as tolylene diisocyanate (TDI), 4,4-diphenylmethane diisocyanate (MDI), hydrogenated TDI and hydrogenated MDI; or an adduct, biuret or isocyanurate of these.

Examples of blocked polyisocyanate compounds include compounds obtained by blocking isocyanate groups in polyisocyanate compounds with, for example, alcohols such as butanol; oxime compounds such as methyl ethyl ketooxime; lactam compounds such as E-caprolactam; diketone compounds such as acetylacetone; ketoester compounds such as acetoacetic acid esters; dicarboxylic acid esters such as diethyl malonate; imidazole compounds such as imidazole and 2-ethylimidazole; and phenol compounds such as m-cresol.

In cases where a polyisocyanate compound and/or a blocked polyisocyanate compound is used as the curing agent, the NCO/OH molar ratio in the aqueous colored coating composition is preferably 0.5-1.5, and more preferably 0.8-1.2, from the perspectives of adhesion to an object to be coated and coating film appearance.

A hydrophilic carbodiimide compound is preferred as the polycarbodiimide compound. Examples of hydrophilic carbodiimide compounds include compounds obtained by reacting a polycarbodiimide compound having 2 or more isocyanate groups per molecule and a polyol having a hydroxyl group at a molecular terminal at proportions so that the NCO/OH molar ratio is greater than 1, and then reacting the thus obtained reaction product with a hydrophilizing agent having an active hydrogen and a hydrophilic moiety.

In cases where a polycarbodiimide compound is used as the curing agent, the NCN/COOH molar ratio in the aqueous colored coating composition is preferably 0.5-2.0, and more preferably 0.8-1.5, from the perspectives of adhesion to an object to be coated and coating film appearance.

Examples of curing agents for the aqueous second colored coating composition include amino resins. It is possible to adjust the elongation percentage of the second colored coating film by introducing a low molecular weight amino resin, such as a melamine resin, as a curing agent into the second colored coating composition and crosslinking.

In cases where an amino resin is used as a curing agent in the second colored coating composition, the solid content mass ratio expressed by (base resin/amino resin) is preferably 1.0-4.0, and more preferably 1.8-3.0, from the perspectives of adhesion to an object to be coated, water resistance, chipping resistance and low temperature impact properties.

The form of the aqueous colored coating compositions of the present invention is not particularly limited as long as the compositions are aqueous, and examples thereof include water-soluble compositions, water-dispersible compositions and aqueous emulsions.

### (3) Clear Coating Composition

The clear coating composition used in the method for forming a multilayer film of the present invention may be an organic solvent-based coating material, an aqueous coating material or a powder coating material. The base resin of the clear coating composition is one or more types selected from among acrylic resins, polyester resins and alkyd resins, and examples of curing systems include melamine curing, acid/epoxy curing and isocyanate curing, but from the perspective of coating film appearance, it is preferable to use an acrylic resin/isocyanate curing type clear coating composition.

The hydroxyl group-containing acrylic resin is not particularly limited, but can be obtained using a publicly known method, such as radical copolymerization of an ethylenically unsaturated monomer such as an acrylic monomer. Such ethylenically unsaturated monomers contain, as an essential constituent component, one or more hydroxyl group-containing monomers, for example an ester obtained by means of a hydroxyl group-containing alkyl group, such as a 2-hydroxyethyl ester, 3-hydroxypropyl ester or 4-hydroxybutyl ester of acrylic acid or methacrylic acid, a caprolactone ring-opening adduct of 2-hydroxyethyl acrylate or methacrylate, or an ethylene oxide adduct or propylene oxide adduct of a 4-hydroxybutyl ester of acrylic acid or methacrylic acid.

In addition, examples of other acrylic monomers able to be copolymerized with the hydroxyl group-containing monomer in the hydroxyl group-containing acrylic resin include acrylic acid, methacrylic acid, hydrocarbon group esters such as methyl, ethyl, n-propyl, isopropyl, n-butyl, isobutyl, t-butyl, hexyl, cyclohexyl, 2-ethylhexyl, lauryl and stearyl esters of acrylic acid and methacrylic acid, acrylonitrile, methacrylonitrile, acrylamide and methacrylamide. Examples of other copolymerizable ethylenically unsaturated monomers include styrene, α-methylstyrene, maleic acid and vinyl acetate. It is possible to use one of these copolymerizable monomers in isolation, or a combination of 2 or more types thereof.

Among these copolymerizable monomers, (meth)acrylic acid esters are preferred, t-butyl esters are particularly preferred, and t-butyl methacrylate is most preferred. The quantity of t-butyl methacrylate is not particularly limited, but is preferably 20 mass % or more of t-butyl methacrylate relative to a total of 100 mass % of raw material monomers for the acrylic resin, and preferred specific examples of this quantity include 20 mass %, 30 mass %, 40 mass %, 50 mass %, 60 mass %, 70 mass %, 80 mass % and 90 mass %, and it is possible to use a quantity range that falls between two of the numerical values listed here.

From the perspective of achieving good chipping resistance, the polyisocyanate compound used for isocyanate curing of the clear coating composition is preferably an aliphatic polyisocyanate compound. The blending proportions of the hydroxyl group-containing acrylic resin and the curing agent should be similar to blending proportions in ordinary 2-component urethane type coating materials.

Furthermore, by adding a melamine resin to the clear coating composition, it is possible to control the crosslinking density and elongation percentage of a cured clear coating film. By adding a melamine resin, the crosslinking density in a cured clear coating film increases. However, the elongation percentage of the clear coating film decreases. Therefore, by adding this melamine resin, it is possible to reduce the elongation percentage of a clear coating film to 3% or less.

The elongation percentage of the clear coating film is a value obtained by applying the clear coating composition to a polypropylene-made plate by means of air spray in the manner such that the dry film thickness is 30 μm, heating and curing at 120° C. for 30 minutes, preparing a strip-shaped measurement sample (10×70 mm) from the film, and then measuring the elongation percentage by using a “TENSILON UTM type III” tensile tester (manufactured by A&D Co. Ltd.). The measurement is carried out at a temperature of 20° C. and a pulling rate of 4 mm/min with a measurement length of 40 mm. The elongation percentage is the average value in 5 measurements.

It is preferable for a cured coating film of the clear coating composition to have a glass transition temperature of 70° C. or higher. If this glass transition temperature is lower than 70° C., cured film hardness is insufficient.

The glass transition temperature of the clear coating film is a value obtained by applying the clear coating composition to a polypropylene-made plate by means of air spray in the manner such that the dry film thickness is 30 μm, heating and curing at 120° C. for 30 minutes, and then measuring the glass transition temperature by using a “DSC-50” differential scanning calorimeter (manufactured by Shimadzu Corp.) in the range of from −80° C. to 120° C. at a rate of temperature increase of 5° C./min. The glass transition temperature mentioned in the present specification is a transition initiation temperatures in the DSC (differential scanning calorimetry).

In addition to the resin component mentioned above, the clear coating composition used in the present invention may contain additives such as ultraviolet radiation absorbers such as benzotriazole compounds, photostabilizers such as hindered amine compounds, curing catalysts such as organic tin compounds, fluidity-controlling agents such as waxes, and additives such as anti-foaming agents and leveling agents.

The form of the clear coating composition used in the present invention is not particularly limited, but is preferably an organic solvent-based coating material that is dissolved or dispersed in an aromatic solvent such as toluene or xylene, an aliphatic solvent such as mineral spirits, an ester-based solvent such as ethyl acetate or butyl acetate, a ketone-based solvent such as methyl ethyl ketone, or an organic solvent obtained by mixing 2 or more of these solvents.

### (4) Coating Method

Methods commonly used in the motor vehicle industry, such as air spray coating, air atomization electrostatic coating or rotary bell atomization electrostatic coating, can be used as methods for coating the coating materials in the method for forming a multilayer coating film of the present invention.

In the method for forming a multilayer coating film of the present invention, coating conditions for the aqueous colored coating compositions (the aqueous first and aqueous second colored coating compositions) are preferably a temperature of 10° C. to 40° C. and a relative humidity of 65-85%.

In the method for forming a multilayer coating film of the present invention, pre-heating may be carried out after coating the aqueous primer coating composition, after coating the aqueous first colored coating composition or after coating the aqueous second colored coating composition, but in cases where aqueous colored coating compositions such as those mentioned above are used, excellent coating film appearance can be achieved without pre-heating after coating the aqueous primer coating composition and/or after coating the aqueous first colored coating composition. Moreover, “pre-heating” is heating that is carried out by regulating at least one of the temperature and the duration so that the coating composition is not completely cured.

In cases where the curing agent for the aqueous first colored coating composition is a polyisocyanate compound and/or a carbodiimide compound in the method for forming a multilayer coating film of the present invention, by using a melamine resin-containing isocyanate curing type clear coating composition, it is possible for the heat curing temperature of the multilayer coating film to be 80° C. to 120° C. The heat curing duration is preferably 30-50 minutes.

The coating compositions used in the present invention can be coated on two coated objects, namely pre-coated steel sheets and pre-treated plastic base materials for motor vehicles. That is, the method of the present invention is particularly suitable for coating, on the surface to be coated, articles on which both pre-coated steel sheets and pre-treated plastic base materials are exposed, and is not particularly limited as long as this condition is satisfied. Here, the term “pre-coat” is not particularly limited as long as this is a type of material that is routinely coated on steel sheets of motor vehicles, and is, for example, an electrodeposition film.

The plastic base material pre-treatment is not particularly limited, but includes cleaning (degreasing) a plastic base material, and detergents used for the cleaning are not particularly limited. Examples of detergents include isopropyl alcohol, which has little effect on plastic base materials. The type of plastic base material is not particularly limited, and can be a type of plastic that is widely used in motor vehicle applications, but the plastic base material is formed, for example, using one or more types of resin material selected from among PP resins (polypropylene), ABS resins (acrylonitrile-butadiene-styrene), PC resins (polycarbonates) and composite materials of these (ABS/PP resins and the like), and also includes materials obtained by adding additives such as fillers to resin materials.

A multilayer coating film obtained using the formation method of the present invention obviously exhibits excellent initial appearance, but is unlikely to suffer from localized coating film detachment even in low temperature environments where small stones and the like impact strongly as a vehicle is running at high speed in cold regions, and can maintain an attractive coated surface.

### WORKING EXAMPLES

The present invention will now be explained in greater detail through the use of working examples, but is not limited to these working examples. In the working examples, the term “parts” means “parts by mass” and use of the symbol “%” relating to blending quantities and content values means “mass %”, unless explicitly indicated otherwise.

### Production Example 1

### Production of Non-Chlorinated Polyolefin Resin Aqueous Dispersion P-1

A non-chlorinated polyolefin resin aqueous dispersion used in the present invention is produced using the following three-stage process.

### (i) First Stage: Production of Non-Chlorinated Polyolefin Resin

110 mL of deionized water, 22.2 g of magnesium sulfate heptahydrate and 18.2 g of sulfuric acid were placed in a 1000 mL round-bottomed flask and dissolved under stirring. 16.7 g of commercially available granular montmorillonite was dispersed in this solution, heated to 100° C. and stirred for 2 hours. This dispersion was then cooled to room temperature, the obtained slurry was filtered, and a wet cake was recovered. The recovered cake was re-slurrified with 500 mL of demineralized water in a 1000 mL round-bottomed flask, and then filtered. This procedure was repeated twice. 13.3 g of chemically treated montmorillonite was obtained by drying the ultimately obtained cake overnight at 110° C. in a nitrogen atmosphere. 20 mL of a (0.4 mmol/mL) toluene solution of triethyl aluminum was added to 4.4 g of the obtained chemically treated montmorillonite and stirred for 1 hour at room temperature. 80 mL of toluene was added to this suspension and stirred, after which the supernatant liquid was removed. After repeating this procedure twice, a clay slurry (slurry concentration: 99 mg clay/mL) was obtained by adding toluene.

A catalyst slurry was obtained by placing 0.2 mmol of triisobutyl aluminum in another flask, adding 19 mL of the obtained clay slurry and a toluene dilution solution of 131 mg (57 μmol) of dichloro[dimethylsilylene(cyclopentadienyl)(2,4-dimethyl-4H-5,6,7,8-tetrahydro-1-azulenyl) hafnium and stirring for 10 minutes at room temperature.

Next, 11 L of toluene, 3.5 mmol of triisobutyl aluminum and 2.64 L of liquid propylene were placed in an induction stirring type autoclave having an internal volume of 24 L. The entire quantity of the catalyst slurry was introduced to the autoclave at room temperature, the temperature was increased to 62° C., and stirring was continued for 2 hours at the same temperature while maintaining the overall pressure at a constant 0.65 MPa during polymerization. Following completion of the stirring, unreacted propylene was purged so as to stop the polymerization. The autoclave was opened, the entire quantity of the toluene solution of the polymer was recovered, and when the solvent and clay residue was removed, 11 kg of an 11.0% toluene solution of a propylene-based polymer was obtained. The weight average molecular weight Mw of the obtained propylene-based polymer was 210,000.

### (ii) Second Stage: Production of Maleic Anhydride-Modified Non-Chlorinated Polyolefin Resin

200 g of the propylene-based polymer obtained in the first stage described in (i) above and 300 g of toluene were placed in a glass flask fitted with a reflux condenser tube, a thermometer and a stirrer, the inside of the flask was purged with nitrogen, and the temperature was increased to 110° C. After increasing the temperature, 12 g of maleic anhydride was added, 6 g of t-butylperoxyisopropyl monocarbonate (Perbutyl I manufactured by NOF Corp.) was added, and a reaction was carried out by continuing the stirring at the same temperature for a period of 7 hours. Following completion of the reaction, the system was allowed to cool to approximately room temperature, acetone was added, and the thus precipitated polymer was filtered. Furthermore, precipitation with acetone and filtration were repeated, and the ultimately obtained polymer was washed with acetone. A white powdery maleic anhydride-modified polymer was obtained by subjecting the washed polymer to vacuum drying. When this modified polymer was subjected to infrared absorption spectrum analysis, the content of maleic anhydride groups (the graft ratio was 1.3% (0.13 mmol as maleic anhydride groups per 1 g of propylene-based polymer), the weight average molecular weight was 120,000, and the melting point, as measured using a “DSC-50” differential scanning calorimeter, was 80° C.

(iii) Third Stage: Production of Aqueous Dispersion of Maleic Anhydride-Modified Non-Chlorinated Polyolefin Resin

100 g of the maleic anhydride-modified propylene-based polymer (maleic anhydride group content: 13 mmol) obtained in the second stage described in (ii) above and 250 g of toluene were placed in a glass flask fitted with a reflux condenser tube, a thermometer and a stirrer, the temperature was increased to 110° C., and the materials in the flask were completely dissolved. Next, a solution obtained by dissolving 30 g (30.0 mmol, corresponding to 30 parts by mass relative to 100 parts by mass of the propylene-based polymer) of a poly(oxyethylene/oxypropylene) block copolymer (molecular weight 1000) in 22.5 g of toluene was added to the flask, and a reaction was carried out for 3 hours at 110° C.

After cooling, 115 g of a yellow polymer was obtained by distilling off the toluene under reduced pressure. When the thus obtained product was subjected to infrared absorption spectrum analysis, a peak at approximately 1784 cm⁻¹, which was attributable to maleic anhydride, had disappeared, and it was confirmed that the maleic anhydride-modified propylene-based polymer was bonded to a polyether. A graft copolymer was formed in which a polyether was graft-bonded to the maleic anhydride-modified propylene-based polymer. 160 g of tetrahydrofuran (THF) was added to 40 g of the obtained modified polymer, and the modified polymer was completely dissolved at 65° C. A semi-transparent pale yellow solution was obtained by adding 200 g of pure water dropwise over a period of 1 hour at the same temperature. Semitransparent pale yellow polyolefin resin aqueous dispersion P-1 was obtained by cooling this solution to 50° C., gradually reducing the pressure by altering the degree of vacuum from 0.03 MPa to 0.0045 MPa, and distilling off THF and water under reduced pressure until the solid resin content reached 30%.

Moreover, the poly(oxyethylene/oxypropylene) block copolymer used in the present working example had an insoluble component content of 1 mass % or less when dissolved at a concentration of 10 mass % in water at 25° C., and was a hydrophilic polymer.

### Production Example 2

### Production of Aqueous Primer Coating Composition WP-1

Aqueous primer coating composition WP-1 was produced by adding 1.66 parts of electrically conductive carbon black “Printex XE2B” (manufactured by Degussa), 12.55 parts of titanium dioxide “JR600-E” (manufactured by Tayca Corp.) and 0.93 parts of a pigment dispersing agent “Disperbyk 191” (manufactured by BYK Chemie, solid content 98%, acid value 31 mg KOH/g, amine value 20 mg KOH/g) to 26.5 parts of a polyurethane resin “Impranil DLU” (manufactured by Covestro Japan Ltd., solid resin content 60%, Tg −83° C., elongation percentage 800%), dispersing these components by means of a disperser, adding 21.0 parts of non-chlorinated polyolefin resin aqueous dispersion P-1, 1.5 parts of a curing agent “DURANATE WM4 4-L70G” (a water-dispersed blocked polyisocyanate compound manufactured by Asahi Kasei Chemicals Corporation, solid resin content 70%), 33.96 parts of deionized water, 0.8 parts of a leveling agent “BYK-348” (manufactured by BYK Chemie) and 1.1 parts of a thickening agent “Rheovis AS S130” (manufactured by BASF, solid content 30%), mixing in a dissolver and adjusting the pH to 7-8 by means of dimethylethanolamine.

### Production Example 3

### Production of Aqueous Primer Coating Compositions WP-2 to WP-18

Aqueous primer coating compositions WP-2 to WP-18 were obtained on the basis of the formulations shown in Table 1, using the same method as that used in Production Example 2.

TABLE 1

| Aqueous primer coating composition | | WP-1 | WP-2 | WP-3 | WP-4 | WP-5 |
|---|---|---|---|---|---|---|
| A: Polyolefin | Non-chlorinated | 21 | 21 | 21 | 21 | 21 |
| resin | polyolefin | | | | | |
| | resin aqueous | | | | | |
| | dispersion P-1 | | | | | |
| B: | Impranil DLU | 26.5 | | | | |
| Polyurethane | Acrit WBR-2181 (*1) | | 48.18 | | | |
| resin | Permarin UA-150 (*2) | | | 53 | | |
| | Ucoat DA-100 (*3) | | | | 45.43 | |
| | Takelac W6061 (*4) | | | | | 53 |
| | Bayhydrol UH2952/1 | | | | | |
| | (*5) | | | | | |
| | Lacstar 5215A (*6) | | | | | |
| C: Curing | Duranate WM44-L70G | 1.5 | 1.5 | 1.5 | 1.5 | 1.5 |
| agent | Mycoat 775 (*7) | | | | | |
| D: | Printex XE2B | 1.66 | 1.66 | 1.66 | 1.66 | 1.66 |
| Electrically | | | | | | |
| conductive | | | | | | |
| carbon | | | | | | |
| Titanium | JR600-E | 12.55 | 12.55 | 12.55 | 12.55 | 12.55 |
| dioxide | | | | | | |
| Pigment | Disperbyk 191 | 0.93 | 0.93 | 0.93 | 0.93 | 0.93 |
| dispersing | | | | | | |
| agent | | | | | | |
| Leveling agent | BYK-348 | 0.8 | 0.8 | 0.8 | 0.8 | 0.8 |
| Thickening | Rheovis AS S130 | 1.1 | 1.1 | 1.1 | 1.1 | 1.1 |
| agent | | | | | | |
| | Deionized water | 33.96 | 12.28 | 7.46 | 15.03 | 7.46 |
| Total | | 100 | 100 | 100 | 100 | 100 |
| A: Polyolefin | Melting point (° C.) | 80 | 80 | 80 | 80 | 80 |
| resin | Weight average | 120,000 | 120,000 | 120,000 | 120,000 | 120,000 |
| | molecular weight | | | | | |
| B: | Glass transition | −83 | −89 | −87 | −80 | −78 |
| Polyurethane | temperature (° C.) | | | | | |
| resin | Elongation percentage | 800 | 700 | 600 | 500 | 1000 |
| | (%) | | | | | |

| | | | | | |
|---|---|---|---|---|---|
| A/B | 28/72 | 28/72 | 28/72 | 28/72 | 28/72 |
| C/(A + B) | 5/100 | 5/100 | 5/100 | 5/100 | 5/100 |
| D/(A + B + C) | 7/93 | 7/93 | 7/93 | 7/93 | 7/93 |

| Aqueous primer coating composition | | WP-6 | WP-7 | WP-8 | WP-9 |
|---|---|---|---|---|---|
| A: Polyolefin | Non-chlorinated | 21 | 21 | 21 | 14.8 |
| resin | polyolefin | | | | |
| | resin aqueous | | | | |
| | dispersion P-1 | | | | |
| B: | Impranil DLU | | | 26.5 | 29.6 |
| Polyurethane | Acrit WBR-2181 (*1) | | | | |
| resin | Permarin UA-150 (*2) | | | | |
| | Ucoat DA-100 (*3) | | | | |
| | Takelac W6061 (*4) | | | | |
| | Bayhydrol UH2952/1 | 39.75 | | | |
| | (*5) | | | | |
| | Lacstar 5215A (*6) | | 33.61 | | |
| C: Curing | Duranate WM44-L70G | 1.5 | 1.5 | | 1.5 |
| agent | Mycoat 775 (*7) | | | 2 | |
| D: | Printex XE2B | 1.66 | 1.66 | 1.66 | 1.66 |
| Electrically | | | | | |
| conductive | | | | | |
| carbon | | | | | |
| Titanium | JR600-E | 12.55 | 12.55 | 12.55 | 12.55 |
| dioxide | | | | | |
| Pigment | Disperbyk 191 | 0.93 | 0.93 | 0.93 | 0.93 |
| dispersing | | | | | |
| agent | | | | | |
| Leveling agent | BYK-348 | 0.8 | 0.8 | 0.8 | 0.8 |
| Thickening | Rheovis AS S130 | 1.1 | 1.1 | 1.1 | 1.1 |
| agent | | | | | |
| | Deionized water | 20.71 | 26.85 | 33.46 | 37.06 |
| Total | | 100 | 100 | 100 | 100 |
| A: Polyolefin | Melting point (° C.) | 80 | 80 | 80 | 80 |
| resin | Weight average | 120,000 | 120,000 | 120,000 | 120,000 |
| | molecular weight | | | | |
| B: | Glass transition | −49 | −60 | −83 | −83 |
| Polyurethane | temperature (° C.) | | | | |
| resin | Elongation percentage | 530 | 250 | 800 | 800 |
| | (%) | | | | |

| | | | | |
|---|---|---|---|---|
| A/B | 28/72 | 28/72 | 28/72 | 20/80 |
| C/(A + B) | 5/100 | 5/100 | 6/100 | 5/100 |
| D/(A + B + C) | 7/93 | 7/93 | 7/93 | 7/93 |

| Aqueous primer coating composition | | WP-10 | WP-11 | WP-12 | WP-13 | WP-14 |
|---|---|---|---|---|---|---|
| A: Polyolefin | Non-chlorinated | 29.6 | 59.2 | 62.9 | 21 | 21 |
| resin | polyolefin | | | | | |
| | resin aqueous | | | | | |
| | dispersion P-1 | | | | | |
| B: | Impranil DLU | 22.2 | 7.4 | 5.55 | 26.5 | 26.5 |
| Polyurethane | Acrit WBR-2181 (*1) | | | | | |
| resin | Permarin UA-150 (*2) | | | | | |
| | Ucoat DA-100 (*3) | | | | | |
| | Takelac W6061 (*4) | | | | | |
| | Bayhydrol UH2952/1 | | | | | |
| | (*5) | | | | | |
| | Lacstar 5215A (*6) | | | | | |
| C: Curing | Duranate WM44-L70G | 1.5 | 1.5 | 1.5 | 0.32 | 3.1 |
| agent | Mycoat 775 (*7) | | | | | |
| D: | Printex XE2B | 1.66 | 1.66 | 1.66 | 1.66 | 1.66 |
| Electrically | | | | | | |
| conductive | | | | | | |
| carbon | | | | | | |
| Titanium | JR600-E | 12.55 | 12.55 | 12.55 | 12.55 | 12.55 |
| dioxide | | | | | | |
| Pigment | Disperbyk 191 | 0.93 | 0.93 | 0.93 | 0.93 | 0.93 |
| dispersing | | | | | | |
| agent | | | | | | |
| Leveling agent | BYK-348 | 0.8 | 0.8 | 0.8 | 0.8 | 0.8 |
| Thickening | Rheovis AS S130 | 1.1 | 1.1 | 1.1 | 1.1 | 1.1 |
| agent | | | | | | |
| | Deionized water | 29.66 | 14.86 | 13.01 | 35.14 | 32.36 |
| Total | | 100 | 100 | 100 | 100 | 100 |
| A: Polyolefin | Melting point (° C.) | 80 | 80 | 80 | 80 | 80 |
| resin | Weight average | 120,000 | 120,000 | 120,000 | 120,000 | 120,000 |
| | molecular weight | | | | | |
| B: | Glass transition | −83 | −83 | −83 | −83 | −83 |
| Polyurethane | temperature (° C.) | | | | | |
| resin | Elongation percentage | 800 | 800 | 800 | 800 | 800 |
| | (%) | | | | | |

| | | | | | |
|---|---|---|---|---|---|
| A/B | 40/60 | 80/20 | 85/15 | 28/72 | 28/72 |
| C/(A + B) | 5/100 | 5/100 | 5/100 | 1/100 | 10/100 |
| D/(A + B + C) | 7/93 | 7/93 | 7/93 | 7/93 | 7/93 |

| Aqueous primer coating composition | | WP-15 | WP-16 | WP-17 | WP-18 |
|---|---|---|---|---|---|
| A: Polyolefin | Non-chlorinated | 18.3 | 21 | 21 | 21 |
| resin | polyolefin | | | | |
| | resin aqueous | | | | |
| | dispersion P-1 | | | | |
| B: | Impranil DLU | 21.5 | 26.5 | 26.5 | 26.5 |
| Polyurethane | Acrit WBR-2181 (*1) | | | | |
| resin | Permarin UA-150 (*2) | | | | |
| | Ucoat DA-100 (*3) | | | | |
| | Takelac W6061 (*4) | | | | |
| | Bayhydrol UH2952/1 | | | | |
| | (*5) | | | | |
| | Lacstar 5215A (*6) | | | | |
| C: Curing | Duranate WM44-L70G | 7.8 | 1.5 | 1.5 | 1.5 |
| agent | Mycoat 775 (*7) | | | | |
| D: | Printex XE2B | 1.66 | 0.47 | 3.21 | 5 |
| Electrically | | | | | |
| conductive | | | | | |
| carbon | | | | | |
| Titanium | JR600-E | 12.55 | 3.55 | 24.27 | 37.65 |
| dioxide | | | | | |
| Pigment | Disperbyk 191 | 0.93 | 0.26 | 1.8 | 2.5 |
| dispersing | | | | | |
| agent | | | | | |
| Leveling agent | BYK-348 | 0.8 | 0.8 | 0.8 | 0.8 |
| Thickening | Rheovis AS S130 | 1.1 | 1.1 | 1.1 | 1.1 |
| agent | | | | | |
| | Deionized water | 25.95 | 44.82 | 19.82 | 3.95 |
| Total | | 90.59 | 100 | 100 | 100 |
| A: Polyolefin | Melting point (° C.) | 80 | 80 | 80 | 80 |
| resin | Weight average | 120,000 | 120,000 | 120,000 | 120,000 |
| | molecular weight | | | | |
| B: | Glass transition | −83 | −83 | −83 | −83 |
| Polyurethane | temperature (° C.) | | | | |
| resin | Elongation percentage | 800 | 800 | 800 | 800 |
| | (%) | | | | |

| | | | | |
|---|---|---|---|---|
| A/B | 30/70 | 28/72 | 28/72 | 28/72 |
| C/(A + B) | 30/100 | 5/100 | 5/100 | 5/100 |
| D/(A + B + C) | 7/93 | 2/98 | 14/86 | 22/78 |

Details of blending components shown in Table 1 are as follows.
(*1) Acrit WBR-2181 (manufactured by Taisei Fine Chemical Co,. Ltd., solid resin content 33%, Tg −89° C., elongation percentage 700%)
(*2) Permarin UA-150 (manufactured by Sanyo Chemical Industries, Ltd., solid resin content 30%, Tg −87° C., elongation percentage 600%)
(*3) Ucoat DA-100 (manufactured by Sanyo Chemical Industries, Ltd., solid resin content 35%, Tg −80° C., elongation percentage 500%)
(*4) Takelac W6061 (manufactured by Mitsui Chemicals, Inc., solid resin content 30%, Tg −78° C., elongation percentage 1000%)
(*5) Bayhydrol UH2952/1 (manufactured by Covestro Japan Ltd., solid resin content 40%, Tg −49° C., elongation percentage 530%)
(*6) Lacstar 5215A (manufactured by DIC Corp., solid resin content 47.3%, Tg −60° C., elongation percentage 250%)
(*7) Mycoat 775 (melamine resin, manufactured by Allnex Japan, Inc., solid resin content 70%)

### Production Example 4

### Production of Polyester Resin Varnish PA-1

54.0 parts of a dimer acid (product name “EMPOL 1008”, manufactured by Cognis Corporation, number of carbon atoms: 36), 8.0 parts of neopentyl glycol, 17.8 parts of isophthalic acid, 19.4 parts of 1,6-hexane diol and 0.8 parts of trimethylolpropane were placed in a reaction vessel equipped with a reflux condensing tube, to which a reaction water separation tube was fitted, a nitrogen gas introduction device, a thermometer and a stirring device, the temperature was increased to 120° C. so as to dissolve the raw materials, and the temperature was then increased to 160° C. while stirring the contents of the reaction vessel. The temperature was held at 160° C. for 1 hour, and then gradually increased to 230° C. over a period of 5 hours. Polyester resin varnish PA-1, which had a solid resin content of 74.6%, a hydroxyl value of 62 mg KOH/g, an acid value of 4 mg KOH/g and a number average molecular weight of 1800, was obtained by allowing a reaction to continue while maintaining a temperature of 230° C., cooling to a temperature of 80° C. or lower when the resin acid value reached 4 mg KOH/g, and then adding 31.6 parts of methyl ethyl ketone.

### Production Example 5

### Production of Polyurethane Resin WB-1

78.3 parts of polyester resin solution PA-1, 7.8 parts of dimethylolpropionic acid, 1.4 parts of neopentyl glycol and 40.0 parts of methyl ethyl ketone were placed in a reaction vessel equipped with a nitrogen gas introduction device, a thermometer and a stirring device, the temperature was increased to 80° C. while stirring the contents of the reaction vessel, 27.6 parts of isophorone diisocyanate was added, and the components were allowed to react while maintaining a temperature of 80° C. When the isocyanate value reached 0.43 meq/g, 4.8 parts of trimethylolpropane was added, and the reaction was allowed to continue at a temperature of 80° C. In addition, when the isocyanate value reached 0.01 meq/g, 33.3 parts of butyl cellosolve was added and the reaction was terminated. Next, the temperature was increased to 100° C. and methyl ethyl ketone was removed under reduced pressure. Polyurethane resin WB-1, which had a solid resin content of 35.0%, a hydroxyl value of 40 mg KOH/g, an acid value of 35 mg KOH/g and a number average molecular weight of 4900, was obtained by lowering the temperature to 50° C., adding 4.4 parts of dimethylethanolamine so as to neutralize acid groups, and adding 147.9 parts of deionized water.

### Production Example 6

### Production of Core/Shell Emulsion WC-1

46.4 parts of polyurethane resin WB-1 and 33.1 parts of deionized water were placed in a reaction vessel equipped with a nitrogen gas introduction device, a thermometer, an addition funnel and a stirring device, the temperature was increased to 85° C. while stirring the contents of the reaction vessel, and a homogeneous mixture comprising 4.9 parts of styrene, 4.5 parts of methyl methacrylate, 3.9 parts of n-butyl acrylate, 3.0 parts of 2-hydroxyethyl methacrylate, 3.8 parts of propylene glycol monomethyl ether and 0.24 parts of the polymerization initiator t-butylperoxy-2-ethyl hexanoate as dropwise addition components was added dropwise at constant speed over a period of 3.5 hours using the addition funnel. Following completion of the dropwise addition, core/shell emulsion resin WC-1, which had a solid resin content of 32.5%, was obtained by maintaining a temperature of 85° C. for 1 hour, adding a polymerization initiator solution obtained by dissolving 0.03 parts of the polymerization initiator t-butylperoxy-2-ethylhexanoate in 0.14 parts of propylene glycol monomethyl ether as an additional catalyst, and terminating the reaction after maintaining a temperature of 85° C. for a further 1 hour. The acrylic resin of the core had a hydroxyl value of 80 mg KOH/g and an acid value of 0 mg KOH/g.

### Production Example 7

### Production of Aqueous First Colored Coating Composition WD-1

Using aqueous polyurethane resin WB-1 as a dispersing resin, a pigment paste was prepared by dispersing 33.8 parts of titanium dioxide (product name “Ti-Pure R706”, manufactured by DuPont) and 0.4 parts of carbon black (product name “MA-100”, manufactured by Mitsubishi Chemical Corp.) in a motor mill.

Next, a resin base was prepared by mixing 25.5 parts of core/shell emulsion WC-1, aqueous polyurethane resin WB-1 and 5.9 parts of an aqueous acrylic resin (product name “SETAQUA 6511”, manufactured by Nuplex Resins, acid value 8 mg KOH/g, hydroxyl value 138 mg KOH/g, glass transition temperature 12° C., solid resin content 47%) in a dissolver, and this resin base was added to the previously prepared pigment paste and mixed. Finally, aqueous first colored coating composition WD-1 was obtained by adding and mixing 6.6 parts of a polyisocyanate (product name “Bayhydur 3100”, manufactured by Sumika Bayer Urethane Co., Ltd., solid resin content 100%, NCO content 17.5%). Moreover, the content of aqueous polyurethane resin WB-1 in aqueous first colored coating composition WD-1 was 47.4 parts.

### Production Example 8

### Production of Aqueous First Colored Coating Composition WD-2

Aqueous first colored coating composition WD-2 was obtained on the basis of the formulation shown in Table 2, using the same method as that used in Production Example 7.

TABLE 2

| Aqueous first colored coating composition | WD-1 | WD-2 |
|---|---|---|
| Core/shell emulsion WC-1 (solid resin content 32.5%) | 25.5 | 25.5 |
| Aqueous polyurethane resin WB-1 (solid resin content | 47.4 | 47.4 |
| 35.0%) | | |
| Aqueous acrylic resin (solid resin content 47.0%) | 5.9 | 5.9 |
| Polyisocyanate (*8) | 6.6 | |
| Polycarbodiimide compound (*9) | | 12.8 |
| Titanium dioxide (*10) | 33.8 | 32.4 |
| Carbon black (*11) | 0.4 | 0.4 |
| Total | 119.6 | 124.4 |
| Core/shell emulsion | 30% | 30% |
| Aqueous polyurethane resin | 60% | 60% |
| Aqueous acrylic resin | 10% | 10% |
| NCO/OH (molar ratio) | 1.0 | |
| NCN/COOH (molar ratio) | | 1.0 |
| P/B | 1.0 | 1.0 |

### Production Example 9

### Production of Aqueous Second Colored Coating Composition WE-1

Using aqueous polyurethane resin WB-1 as a dispersing resin, a pigment paste was prepared by dispersing 4.0 parts of carbon black (product name “MA-100”, manufactured by Mitsubishi Chemical Corp.) in a motor mill.

Next, a resin base was prepared by mixing 25.5 parts of core/shell emulsion WC-1, aqueous polyurethane resin WB-1 and 5.9 parts of an aqueous acrylic resin (product name “SETAQUA 6511”, manufactured by Nuplex Resins, acid value 8 mg KOH/g, hydroxyl value 138 mg KOH/g, glass transition temperature 12° C., solid resin content 47%) in a dissolver, and this resin base was added to the previously prepared pigment paste and mixed. Finally, aqueous second colored coating composition WE-1 was obtained by adding and mixing 16.9 parts of a melamine resin (product name “Mycoat 775”, manufactured by Allnex Japan, Inc., solid resin content 70%). Moreover, the content of aqueous polyurethane resin WB-1 in aqueous second colored coating composition WE-1 was 47.4 parts.

### Production Example 10

### Production of Aqueous Second Colored Coating Compositions WE-2 to WE-7

Aqueous second colored coating compositions WE-2 to WE-7 were obtained on the basis of the formulations shown in Table 3, using the same method as that used in Production Example 9.

TABLE 3

| Aqueous second colored coating composition | WE-1 | WE-2 | WE-3 | WE-4 | WE-5 | WE-6 | WE-7 |
|---|---|---|---|---|---|---|---|
| Core/shell emulsion WC-1 (solid resin content 32.5%) | 25.5 | 25.5 | 25.5 | 25.5 | 25.5 | 25.5 | 25.5 |
| Aqueous polyurethane resin WB-1 (solid resin content 35.0%) | 47.4 | 47.4 | 47.4 | 47.4 | 47.4 | 47.4 | 47.4 |
| Aqueous acrylic resin (solid resin content 47.0%) | 5.9 | 5.9 | 5.9 | 5.9 | 5.9 | 5.9 | 5.9 |
| Melamine resin (*7) | 16.9 | 39.5 | 9.9 | 4.4 | | | |
| Polyisocyanate (*8) | | | | | 6.6 | | |
| Polycarbodiimide compound (*9) | | | | | | 12.8 | |
| Carbon black (*11) | 4.0 | 5.0 | 3.5 | 3.0 | 2.5 | 2.4 | 2.1 |
| Total | 99.7 | 123.3 | 92.2 | 86.2 | 87.9 | 94.0 | 80.9 |
| Core/shell emulsion | 30% | 30% | 30% | 30% | 30% | 30% | 30% |
| Aqueous polyurethane resin | 60% | 60% | 60% | 60% | 60% | 60% | 60% |
| Aqueous acrylic resin | 10% | 10% | 10% | 10% | 10% | 10% | 10% |
| NCO/OH (molar ratio) | | | | | 1.0 | | |
| NCN/COOH (molar ratio) | | | | | | 1.0 | |
| Base resin/melamine resin (solid content mass ratio) | 2.3 | 1.0 | 4.0 | 9.0 | | | |
| P/B | 0.1 | 0.1 | 0.1 | 0.1 | 0.1 | 0.1 | 0.1 |

Details of blending components shown in Tables 2-3 are as follows.
(*7) Melamine resin (product name “Mycoat 775”, manufactured by Allnex Japan, Inc., solid resin content 70%)
(*8) Polyisocyanate (product name “Bayhydur 3100”, manufactured by Sumika Bayer Urethane Co., Ltd., NCO 17.5%)
(*9) Polycarbodiimide (product name “Carbodilite V-02-L2”, manufactured by Nisshinbo Chemical Inc., NCN 4.15%) (*10) Titanium dioxide (product name “Ti-Pure R706”, manufactured by DuPont)
(*11) Carbon black (product name “MA-100”, manufactured by Mitsubishi Chemical Corp.)

### Production Example 11

### Production of Clear Coating Composition CC-1

### (i) Production of Acrylic Resin Solution CA-1 for Clear Coating

5 parts of “Solvesso 100” was placed in a four-mouthed flask equipped with a thermometer, a reflux condenser, a stirrer and an addition funnel, and the flask was heated and maintained at a temperature of 140° C. while stirring the Solvesso 100 in a nitrogen stream. Next, 7.8 parts of styrene, 0.2 parts of n-butyl methacrylate, 6.3 parts of 2-ethylhexyl acrylate, 1 part of isobutyl methacrylate, 14.1 parts of 2-hydroxyethyl methacrylate, 0.2 parts of hydroxypropyl methacrylate, 4.4 parts of 2-ethylhexyl methacrylate, 6.9 parts of cyclohexyl methacrylate, 0.2 parts of n-butyl acrylate, 0.4 parts of acrylic acid and 20.5 parts of t-butyl methacrylate were homogeneously mixed and used as monomer components added dropwise. Meanwhile, 2 parts of Solvesso 100 was homogeneously mixed under stirring with 3.6 parts of Perbutyl Z (t-butylperoxy benzoate, manufactured by NOF Corp. and used as an initiator component added dropwise. The monomer components added dropwise and initiator component added dropwise were placed in separate addition funnels, and simultaneously added dropwise at the same rate over a period of 4 hours. Following completion of the dropwise addition, the same temperature was maintained for a period of 1 hour, after which a solution obtained by stirring and homogeneously mixing 1 part of Solvesso 100 and 0.1 parts of Perbutyl Z, was separated into several portions, which were added dropwise within a period of 30 minutes. Next, acrylic resin solution CA-was obtained by terminating the reaction once a temperature of 140° C. had been maintained for a further 1 hour and then using 16.1 parts of xylene, 6.4 parts of methoxypropyl acetate and 3.8 parts of butyl acetate as thinning agents. Acrylic resin CA-1 had a solid resin content of 62%, a hydroxyl value of 100 mg KOH/g, an acid value of 5 mg KOH/g and a weight average molecular weight of 3,500.

### (ii) Production of Acrylic Resin Solutions CA-2 to CA-4 for Clear Coating

Acrylic resin solutions CA-2 to CA-4 for clear coating were obtained on the basis of the formulations shown in Table 4, using the same method as that used in Production Example 11 (i).

TABLE 4

| | Acrylic resin solution | | | |
|---|---|---|---|---|
| | for clear coating | | | |
| | CA-1 | CA-2 | CA-3 | CA-4 |
| Styrene | 7.8 | 4.6 | 9.2 | 6 |
| n-butyl methacrylate | 0.2 | 1.7 | 6.2 | |
| 2-ethylhexyl acrylate | 6.3 | | | 15.4 |
| Isobutyl methacrylate | 1 | 1.2 | | 11.1 |
| 4-hydroxybutyl acrylate | | | | 20.9 |
| 2-hydroxyethyl methacrylate | 14.1 | 16.8 | 25.7 | |
| Hydroxypropyl methacrylate | 0.2 | | | |
| Methyl methacrylate | | | | 6 |
| 2-ethylhexyl methacrylate | 4.4 | 2.4 | 20 | |
| Cyclohexyl methacrylate | 6.9 | 12 | | |
| n-Butyl acrylate | 0.2 | | | |
| Acrylic acid | 0.4 | 0.9 | 0.9 | 0.6 |
| t-butyl methacrylate | 20.5 | 12.1 | | |
| ε-caprolactone | | 11.3 | | |
| Perbutyl Z | 3.7 | 4.2 | 4.5 | 1.2 |
| Xylene | 16.1 | 6.3 | | 7.7 |
| Solvesso 100 | 8 | 20.5 | 7 | |
| Methoxypropyl acetate | 6.4 | | | 31.1 |
| Butyl acetate | 3.8 | 6 | 26.5 | |
| Total | 100 | 100 | 100 | 100 |
| Solid resin content (%) | 62 | 63 | 62 | 60 |
| Hydroxyl value (mg KOH/g) | 100 | 120 | 180 | 140 |
| Acid value (mg KOH/g) | 5 | 4.5 | 6 | 3.5 |
| Weight average molecular weight | 3500 | 4500 | 5500 | 5500 |

(iii) Production of Clear Coating Composition CC-1

80 parts of acrylic resin solution CA-1 was placed in a vessel equipped with a stirrer, 8 parts of Solvesso 100 (manufactured by Exxon Mobile, aromatic naphtha), 3 parts of xylene, 0.1 parts of BYK-300 (manufactured by BYK, surface modifier, 10 mass % xylene solution), 2.5 parts of Tinuvin 292 (manufactured by Ciba Specialty Chemicals, photostabilizer, 20 mass % xylene solution) and 5 parts of Tinuvin 900 (manufactured by Ciba Specialty Chemicals, ultraviolet radiation absorber, 20 mass % xylene solution) were placed in the vessel in that order while being stirred, and homogeneously mixed. Next, 1 part of Flownon SH-290 (manufactured by Kyoeisha Chemical Co., Ltd., viscosity-adjusting agent, 10 mass % xylene solution), 0.4 parts of Neostann U-100 (manufactured by Johoku Chemical Co., Ltd., isocyanate curing catalyst, 1 mass % xylene solution) and 6 parts of a melamine resin (product name “U-VAN225”, manufactured by Mitsui Chemicals, Inc., solid resin content 60%) were added in that order while being stirred and then thoroughly stirred so as to obtain a homogeneous mixture. Clear coating composition CC-1 was obtained by charging and stirring 40 parts of Duranate THA-100 (manufactured by Asahi Kasei Corp. HMDI-based nurate type polyisocyanate curing agent, solid resin content 75%, NCO content 23.1%) and 15 parts of a mixed solvent comprising Solvesso 100/butyl acetate/propylene glycol monomethyl ether acetate (blending ratio: 60/20/20) relative to 100 parts of the obtained mixture immediately before use, and stirring until sufficiently homogenized.

### (iv) Production of Clear Coating Compositions CC-2 to CC-8

Clear coating compositions CC-2 to CC-8 were obtained on the basis of the formulations shown in Table 5, using the same method as that used in Production Example 11 (iii).

TABLE 5

| Clear coating | | | | | | | | |
|---|---|---|---|---|---|---|---|---|
| composition | CC-1 | CC-2 | CC-3 | CC-4 | CC-5 | CC-6 | CC-7 | CC-8 |
| Acrylic resin | 80 | 80 | 80 | 80 | 80 | | | |
| solution CA-1 | | | | | | | | |
| (62%)* | | | | | | | | |
| Acrylic resin | | | | | | 93.1 | — | |
| solution CA-2 | | | | | | | | |
| (63%)* | | | | | | | | |
| Acrylic resin | | | | | | — | 80.1 | |
| solution CA-3 | | | | | | | | |
| (62%)* | | | | | | | | |
| Acrylic resin | | | | | | — | — | 84.4 |
| solution CA-4 | | | | | | | | |
| (60%)* | | | | | | | | |
| Aromatic | 8 | 8 | 8 | 8 | 8 | 8 | 8 | 8 |
| naphtha | | | | | | | | |
| Xylene | 3 | 3 | 3 | 3 | 3 | 3 | 3 | 3 |
| Surface | 0.1 | 0.1 | 0.1 | 0.1 | 0.1 | 0.1 | 0.1 | 0.1 |
| modifier | | | | | | | | |
| Photostabilizer | 2.5 | 2.5 | 2.5 | 2.5 | 2.5 | 2.5 | 2.5 | 2.5 |
| Ultraviolet | 5 | 5 | 5 | 5 | 5 | 5 | 5 | 5 |
| radiation | | | | | | | | |
| absorber | | | | | | | | |
| Viscosity- | 1 | 1 | 1 | 1 | 1 | 1 | 1 | 1 |
| adjusting agent | | | | | | | | |
| Curing catalyst | 0.4 | 0.4 | 0.4 | 0.4 | 0.4 | 0.4 | 0.4 | 0.4 |
| Melamine resin | 6 | — | 1.5 | 9 | 10 | — | — | — |
| Subtotal | 106 | 100 | 101.5 | 109 | 110 | 113.1 | 100.1 | 104.4 |
| Polyisocyanate | 40 | 40 | 40 | 40 | 40 | 40 | 40 | 40 |
| Mixed solvent | 15 | 15 | 15 | 15 | 15 | 15 | 15 | 15 |
| Total | 161 | 155 | 156.5 | 164 | 165 | 168.1 | 155.1 | 159.4 |
| Glass | 84 | 82 | 82 | 84 | 85 | 66 | 71 | 96 |
| transition | | | | | | | | |
| temperature | | | | | | | | |
| (° C.) of | | | | | | | | |
| clear coating | | | | | | | | |
| film | | | | | | | | |
| Elongation | 2.9 | 3.5 | 3.1 | 2 | 1.5 | 5.4 | 3 | 1.8 |
| percentage | | | | | | | | |
| (%) of clear | | | | | | | | |
| coating film | | | | | | | | |

*The numbers in brackets indicate solid resin content

### Working Example 1

A cationic electrodeposition coating material (product name “Cathoguard No. 500” manufactured by BASF Japan

Ltd.) was electrodeposited on a zinc phosphate-treated mild steel sheet so as to have a dried film thickness of 20 μm, and then baked for 25 minutes at 175° C. so as to obtain an electrodeposition film sheet used for the present evaluation (hereinafter referred to as the “electrodeposited sheet”). In addition, a polypropylene base material “SP-853” whose surface had been wiped with isopropyl alcohol was used as a plastic base material.

Aqueous primer coating composition WP-1 was coated on the electrodeposited sheet and the polypropylene base material so as to have a dried film thickness of 6-8 μm. The electrodeposited sheet and polypropylene base material were then allowed to stand at room temperature for 5 minutes, after which the first aqueous base coating composition WD-1 was coated so as to have a dried film thickness of 20 μm. The electrodeposited sheet and polypropylene base material were then allowed to stand at room temperature for 5 minutes, after which the second aqueous base coating composition WE-1 was coated so as to have a dried film thickness of 12 μm. Following the coating, the electrodeposited sheet and polypropylene base material were then allowed to stand at room temperature for 5 minutes, and then pre-heated for 5 minutes at 80° C. After allowing the electrodeposited sheet and polypropylene base material to cool to room temperature, clear coating composition CC-1 was coated so as to have a dried film thickness of 30 μm. Following the coating, the electrodeposited sheet and polypropylene base material were then allowed to stand at room temperature for 10 minutes and then baked for 30 minutes at 80° C. so as to obtain evaluation sheets.

The obtained evaluation sheets were subjected to the following coating film performance evaluations.

### (Coating Film Appearance)

Each obtained evaluation sheet was evaluated visually in terms of coating film appearance according to the following criteria.
∘: Smoothness, glossiness and clarity all good.
Δ: Smoothness, glossiness or clarity somewhat poor.
×: Smoothness, glossiness or clarity extremely poor.

### (Adhesive Properties)

Using a knife, 11 vertical and horizontal cuts were made in each obtained evaluation sheet so as to obtain 100 grid cells measuring 2 mm×2 mm, cellophane tape was strongly bonded to the evaluation sheet, and the number of grid cells in which the coating film remained without becoming detached when the cellophane tape was peeled off in a single movement was evaluated according to the following criteria.
∘: No detachment of coating film (100/100 grid cells).
Δ: Partial detachment of coating film (95-99/100 grid cells).
×: Major detachment of coating film (0-94/100 grid cells).

### (Moisture Resistance)

Each obtained evaluation sheet was allowed to stand for 240 hours in a constant-temperature constant-humidity chamber at a temperature of 50° C. and a humidity of 95%. After being allowed to stand in the chamber, the coated sheets were removed from the chamber and investigated in terms of coating film appearance abnormalities and degree of swelling. In addition, 2 hours after removing the sheets from the chamber, the sheets were evaluated in terms of adhesive properties following a moisture resistance test using the same method as that described above for evaluating adhesive properties. Coating film appearance following a moisture resistance test was evaluated according to the following criteria.
∘: No abnormalities on coating film.
Δ: Minor protrusions or appearance abnormalities on coating film.
×: Swelling or significant appearance abnormalities on coating film.

In addition, adhesive properties following a moisture resistance test were evaluated in the same way as that described above for evaluating adhesive properties.

### (Chipping Resistance)

A test piece-holding stand of a JA-400 gravel chipping test instrument (chipping tester) manufactured by Suga Test Instruments Co., Ltd. was fixed at a right angle to a stone blower port, each of the obtained evaluation sheets was fixed to the test piece-holding stand, 50 g of granite gravel having a grain size of No. 7 was blown at the coating film at −20° C. using 0.4 MPa compressed air, and the degree of chipping of the coating film by the gravel was observed visually and evaluated according to the following criteria.
⊚: The chip size was very small, with defects appearing on the top coat.
∘: The chip size was small, with aqueous coating materials (the compositions used in the present invention) exposed.
Δ: The chip size was small, but the steel sheet was exposed.
×: The chip size was somewhat large, and the steel sheet was significantly exposed.

### (Low Temperature Impact Resistance)

Each evaluation sheet was allowed to stand for 3 hours or more in a constant temperature chamber held in advance at a temperature of −30° C. Within 5 seconds of being removed from the chamber, each evaluation sheet was placed with the coating film facing upwards on a support base of a DuPont impact deformation testing machine specified in JIS K5600 5-3. An impact shaft having a hemispherical tip was placed on the evaluation sheet, after which a weight of 1 kg was dropped onto the impact shaft from a height of 70 cm. A total of three or more tests were carried out, once per evaluation sheet, and cases where 67% or more of the evaluation sheets did not have cracks that passed through the base material and did not undergo coating film detachment were deemed to have withstood the impact.
∘: 67-100%
×: <67%

### Working Examples 2-25, Comparative Examples 1-4

Evaluation sheets were prepared using the aqueous primer coating compositions, aqueous first colored coating compositions, aqueous second colored coating compositions and clear coating compositions shown in Tables 6-7 using the same method as that used in working example 1, and subjected to the coating film performance evaluations. The coating film performance evaluation results are also shown in Tables 6-7.

TABLE 6

| | | Working | Working | Working | Working | Working |
|---|---|---|---|---|---|---|
| | | Example | Example | Example | Example | Example |
| | | 1 | 2 | 3 | 4 | 5 |
| Aqueous primer coating composition | | WP-1 | WP-2 | WP-3 | WP-4 | WP-5 |
| Aqueous first colored coating composition | | WD-1 | WD-1 | WD-1 | WD-1 | WD-1 |
| Aqueous second colored coating composition | | WE-1 | WE-1 | WE-1 | WE-1 | WE-1 |
| Clear coating composition | | CC-1 | CC-1 | CC-1 | CC-1 | CC-1 |
| Composition of aqueous primer coating | | | | | | |
| A: Polyolefin | Melting point (° C.) | 80 | 80 | 80 | 80 | 80 |
| resin | Weight average molecular | 120,000 | 120,000 | 120,000 | 120,000 | 120,000 |
| | weight | | | | | |
| B: Polyurethane | Glass transition | −83 | −89 | −87 | −80 | −78 |
| resin | temperature (° C.) | | | | | |
| | Elongation percentage | 800 | 700 | 600 | 500 | 1000 |
| | (%) | | | | | |
| Composition | A/B | 28/72 | 28/72 | 28/72 | 28/72 | 28/72 |
| | C/(A + B) | 5/100 | 5/100 | 5/100 | 5/100 | 5/100 |
| | D/(A + B + C) | 7/93 | 7/93 | 7/93 | 7/93 | 7/93 |
| Glass transition temperature (° C.) of | | 84 | 84 | 84 | 84 | 84 |
| clear coating film | | | | | | |
| Elongation percentage (%) of clear | | 2.9 | 2.9 | 2.9 | 2.9 | 2.9 |
| coating film | | | | | | |
| Coating film quality | | | | | | |
| Base material: | Coating film appearance | ◯ | ◯ | ◯ | ◯ | ◯ |
| Electrodeposited | Adhesion | ◯ | ◯ | ◯ | ◯ | ◯ |
| sheet | Moisture resistance | ◯ | ◯ | ◯ | ◯ | ◯ |
| | (coating film appearance) | | | | | |
| | Moisture resistance | ◯ | ◯ | ◯ | ◯ | ◯ |
| | (adhesion) | | | | | |
| | Chipping resistance | ⊚ | ⊚ | ⊚ | ⊚ | ◯ |
| Base material: | Coating film appearance | ◯ | ◯ | ◯ | ◯ | ◯ |
| Polypropylene | Adhesion | ◯ | Δ | ◯ | ◯ | Δ |
| | Moisture resistance | ◯ | Δ | ◯ | ◯ | Δ |
| | (coating film appearance) | | | | | |
| | Moisture resistance | ◯ | Δ | ◯ | ◯ | Δ |
| | (adhesion) | | | | | |
| | Chipping resistance | ◯ | ◯ | ◯ | ◯ | ◯ |

| | | Working | Working | Working | Working |
|---|---|---|---|---|---|
| | | Example | Example | Example | Example |
| | | 6 | 7 | 8 | 9 |
| Aqueous primer coating composition | | WP-8 | WP-9 | WP-10 | WP-11 |
| Aqueous first colored coating composition | | WD-1 | WD-1 | WD-1 | WD-1 |
| Aqueous second colored coating composition | | WE-1 | WE-1 | WE-1 | WE-1 |
| Clear coating composition | | CC-1 | CC-1 | CC-1 | CC-1 |
| Composition of aqueous primer coating | | | | | |
| A: Polyolefin | Melting point (° C.) | 80 | 80 | 80 | 80 |
| resin | Weight average molecular | 120,000 | 120,000 | 120,000 | 120,000 |
| | weight | | | | |
| B: Polyurethane | Glass transition | −83 | −83 | −83 | −83 |
| resin | temperature (° C.) | | | | |
| | Elongation percentage | 800 | 800 | 800 | 800 |
| | (%) | | | | |
| Composition | A/B | 28/72 | 20/80 | 40/60 | 80/20 |
| | C/(A + B) | 6/100 | 5/100 | 5/100 | 5/100 |
| | D/(A + B + C) | 7/93 | 7/93 | 7/93 | 7/93 |
| Glass transition temperature (° C.) of | | 84 | 84 | 84 | 84 |
| clear coating film | | | | | |
| Elongation percentage (%) of clear | | 2.9 | 2.9 | 2.9 | 2.9 |
| coating film | | | | | |
| Coating film quality | | | | | |
| Base material: | Coating film appearance | ◯ | ◯ | ◯ | ◯ |
| Electrodeposited | Adhesion | ◯ | ◯ | ◯ | ◯ |
| sheet | Moisture resistance | ◯ | ◯ | ◯ | ◯ |
| | (coating film | | | | |
| | appearance) | | | | |
| | Moisture resistance | ◯ | ◯ | ◯ | ◯ |
| | (adhesion) | | | | |
| | Chipping resistance | ⊚ | ⊚ | ⊚ | ◯ |
| Base material: | Coating film appearance | ◯ | ◯ | ◯ | ◯ |
| Polypropylene | Adhesion | ◯ | ◯ | ◯ | ◯ |
| | Moisture resistance | ◯ | ◯ | ◯ | ◯ |
| | (coating film appearance) | | | | |
| | Moisture resistance | ◯ | Δ | ◯ | ◯ |
| | (adhesion) | | | | |
| | Chipping resistance | ◯ | ◯ | ◯ | ◯ |

| | | Working | Working | Working | Working | Working |
|---|---|---|---|---|---|---|
| | | Example | Example | Example | Example | Example |
| | | 10 | 11 | 12 | 13 | 14 |
| Aqueous primer coating composition | | WP-12 | WP-13 | WP-14 | WP-15 | WP-16 |
| Aqueous first colored coating composition | | WD-1 | WD-1 | WD-1 | WD-1 | WD-1 |
| Aqueous second colored coating composition | | WE-1 | WE-1 | WE-1 | WE-1 | WE-1 |
| Clear coating composition | | CC-1 | CC-1 | CC-1 | CC-1 | CC-1 |
| Composition of aqueous primer coating | | | | | | |
| A: Polyolefin | Melting point (° C.) | 80 | 80 | 80 | 80 | 80 |
| resin | Weight average molecular | 120,000 | 120,000 | 120,000 | 120,000 | 120,000 |
| | weight | | | | | |
| B: Polyurethane | Glass transition | −83 | −83 | −83 | −83 | −83 |
| resin | temperature (° C.) | | | | | |
| | Elongation percentage (%) | 800 | 800 | 800 | 800 | 800 |
| Composition | A/B | 85/15 | 28/72 | 28/72 | 30/70 | 28/72 |
| | C/(A + B) | 5/100 | 1/100 | 10/100 | 30/100 | 5/100 |
| | D/(A + B + C) | 7/93 | 7/93 | 7/93 | 7/93 | 2/98 |
| Glass transition temperature (° C.) of clear | | 84 | 84 | 84 | 84 | 84 |
| coating film | | | | | | |
| Elongation percentage (%) of clear coating | | 2.9 | 2.9 | 2.9 | 2.9 | 2.9 |
| film | | | | | | |
| Coating film quality | | | | | | |
| Base material: | Coating film appearance | ◯ | ◯ | ◯ | ◯ | ◯ |
| Electrodeposited | Adhesion | ◯ | ◯ | ◯ | ◯ | ◯ |
| sheet | Moisture resistance | ◯ | ◯ | ◯ | ◯ | ◯ |
| | (coating film appearance) | | | | | |
| | Moisture resistance | ◯ | ◯ | ◯ | ◯ | ◯ |
| | (adhesion) | | | | | |
| | Chipping resistance | Δ | ◯ | ⊚ | ◯ | ⊚ |
| Base material: | Coating film appearance | ◯ | ◯ | ◯ | ◯ | ◯ |
| Polypropylene | Adhesion | ◯ | ◯ | ◯ | ◯ | ◯ |
| | Moisture resistance | ◯ | ◯ | ◯ | ◯ | ◯ |
| | (coating film appearance) | | | | | |
| | Moisture resistance | ◯ | ◯ | ◯ | ◯ | ◯ |
| | (adhesion) | | | | | |
| | Chipping resistance | ◯ | ◯ | ◯ | ◯ | ◯ |

| | | Working | Working | Working | Working |
|---|---|---|---|---|---|
| | | Example | Example | Example | Example |
| | | 15 | 16 | 17 | 18 |
| Aqueous primer coating composition | | WP-17 | WP-18 | WP-1 | WP-1 |
| Aqueous first colored coating composition | | WD-1 | WD-1 | WD-2 | WD-1 |
| Aqueous second colored coating composition | | WE-1 | WE-1 | WE-1 | WE-2 |
| Clear coating composition | | CC-1 | CC-1 | CC-1 | CC-1 |
| Composition of aqueous primer coating | | | | | |
| A: Polyolefin | Melting point (° C.) | 80 | 80 | 80 | 80 |
| resin | Weight average molecular | 120,000 | 120,000 | 120,000 | 120,000 |
| | weight | | | | |
| B: Polyurethane | Glass transition | −83 | −83 | −83 | −83 |
| resin | temperature (° C.) | | | | |
| | Elongation percentage (%) | 800 | 800 | 800 | 800 |
| Composition | A/B | 28/72 | 28/72 | 28/72 | 28/72 |
| | C/(A + B) | 5/100 | 5/100 | 5/100 | 5/100 |
| | D/(A + B + C) | 14/86 | 22/78 | 7/93 | 7/93 |
| Glass transition temperature (° C.) of clear | | 84 | 84 | 84 | 84 |
| coating film | | | | | |
| Elongation percentage (%) of clear coating | | 2.9 | 2.9 | 2.9 | 2.9 |
| film | | | | | |
| Coating film quality | | | | | |
| Base material: | Coating film appearance | ◯ | ◯ | ◯ | ◯ |
| Electrodeposited | Adhesion | ◯ | ◯ | ◯ | ◯ |
| sheet | Moisture resistance | ◯ | ◯ | ◯ | ◯ |
| | (coating film appearance) | | | | |
| | Moisture resistance | ◯ | ◯ | ◯ | ◯ |
| | (adhesion) | | | | |
| | Chipping resistance | ⊚ | ⊚ | ⊚ | ◯ |
| Base material: | Coating film appearance | ◯ | ◯ | ◯ | ◯ |
| Polypropylene | Adhesion | ◯ | ◯ | ◯ | ◯ |
| | Moisture resistance | ◯ | ◯ | ◯ | ◯ |
| | (coating film appearance) | | | | |
| | Moisture resistance | ◯ | ◯ | ◯ | ◯ |
| | (adhesion) | | | | |
| | Chipping resistance | ◯ | ◯ | ◯ | ◯ |

| | | Working | Working | Working | Working | Working |
|---|---|---|---|---|---|---|
| | | Example | Example | Example | Example | Example |
| | | 19 | 20 | 21 | 22 | 23 |
| Aqueous primer coating composition | | WP-1 | WP-1 | WP-1 | WP-1 | WP-1 |
| Aqueous first colored coating composition | | WD-1 | WD-1 | WD-1 | WD-1 | WD-1 |
| Aqueous second colored coating composition | | WE-3 | WE-4 | WE-5 | WE-6 | WE-7 |
| Clear coating composition | | CC-1 | CC-1 | CC-1 | CC-1 | CC-1 |
| Composition of aqueous primer coating | | | | | | |
| A: Polyolefin | Melting point (° C.) | 80 | 80 | 80 | 80 | 80 |
| resin | Weight average molecular | 120,000 | 120,000 | 120,000 | 120,000 | 120,000 |
| | weight | | | | | |
| B: Polyurethane | Glass transition | −83 | −83 | −83 | −83 | −83 |
| resin | temperature (° C.) | | | | | |
| | Elongation percentage (%) | 800 | 800 | 800 | 800 | 800 |
| Composition | A/B | 28/72 | 28/72 | 28/72 | 28/72 | 28/72 |
| | C/(A + B) | 5/100 | 5/100 | 5/100 | 5/100 | 5/100 |
| | D/(A + B + C) | 7/93 | 7/93 | 7/93 | 7/93 | 7/93 |
| Glass transition temperature (° C.) of clear | | 84 | 84 | 84 | 84 | 84 |
| coating film | | | | | | |
| Elongation percentage (%) of clear coating | | 2.9 | 2.9 | 2.9 | 2.9 | 2.9 |
| film | | | | | | |
| Coating film quality | | | | | | |
| Base material: | Coating film appearance | ◯ | ◯ | ◯ | ◯ | ◯ |
| Electrodeposited | Adhesion | ◯ | ◯ | ◯ | ◯ | ◯ |
| sheet | Moisture resistance | ◯ | ◯ | ◯ | ◯ | ◯ |
| | (coating film appearance) | | | | | |
| | Moisture resistance | ◯ | ◯ | ◯ | ◯ | ◯ |
| | (adhesion) | | | | | |
| | Chipping resistance | ⊚ | ◯ | ⊚ | ⊚ | ⊚ |
| Base material: | Coating film appearance | ◯ | ◯ | ◯ | ◯ | ◯ |
| Polypropylene | Adhesion | ◯ | ◯ | ◯ | ◯ | ◯ |
| | Moisture resistance | ◯ | ◯ | ◯ | ◯ | ◯ |
| | (coating film appearance) | | | | | |
| | Moisture resistance | ◯ | ◯ | ◯ | ◯ | ◯ |
| | (adhesion) | | | | | |
| | Chipping resistance | ◯ | ◯ | ◯ | ◯ | ◯ |

| | | Working | Working | Working | Working |
|---|---|---|---|---|---|
| | | Example | Example | Example | Example |
| | | 24 | 25 | 26 | 27 |
| Aqueous primer coating composition | | WP-1 | WP-1 | WP-1 | WP-1 |
| Aqueous first colored coating composition | | WD-1 | WD-1 | WD-1 | WD-1 |
| Aqueous second colored coating composition | | WE-1 | WE-1 | WE-1 | WE-1 |
| Clear coating composition | | CC-4 | CC-5 | CC-7 | CC-8 |
| Composition of aqueous primer coating | | | | | |
| A: Polyolefin | Melting point (° C.) | 80 | 80 | 80 | 80 |
| resin | Weight average molecular | 120,000 | 120,000 | 120,000 | 120,000 |
| | weight | | | | |
| B: Polyurethane | Glass transition | −83 | −83 | −83 | −83 |
| resin | temperature (° C.) | | | | |
| | Elongation percentage (%) | 800 | 800 | 800 | 800 |
| Composition | A/B | 28/72 | 28/72 | 28/72 | 28/72 |
| | C/(A + B) | 5/100 | 5/100 | 5/100 | 5/100 |
| | D/(A + B + C) | 7/93 | 7/93 | 7/93 | 7/93 |
| Glass transition temperature (° C.) of clear | | 84 | 85 | 71 | 96 |
| coating film | | | | | |
| Elongation percentage (%) of clear coating | | 2 | 1.5 | 3 | 1.8 |
| film | | | | | |
| Coating film quality | | | | | |
| Base material: | Coating film appearance | ◯ | ◯ | ◯ | ◯ |
| Electrodeposited | Adhesion | ◯ | ◯ | ◯ | ◯ |
| sheet | Moisture resistance | ◯ | ◯ | ◯ | ◯ |
| | (coating film appearance) | | | | |
| | Moisture resistance | ◯ | ◯ | ◯ | ◯ |
| | (adhesion) | | | | |
| | Chipping resistance | ⊚ | ◯ | ⊚ | ◯ |
| Base material: | Coating film appearance | ◯ | ◯ | ◯ | ◯ |
| Polypropylene | Adhesion | ◯ | ◯ | ◯ | ◯ |
| | Moisture resistance | ◯ | ◯ | ◯ | ◯ |
| | (coating film appearance) | | | | |
| | Moisture resistance | ◯ | ◯ | ◯ | ◯ |
| | (adhesion) | | | | |
| | Chipping resistance | ◯ | ◯ | ◯ | ◯ |

TABLE 7

| | | Comparative | Comparative | Comparative | Comparative | Comparative |
|---|---|---|---|---|---|---|
| | | Example 1 | Example 2 | Example 3 | Example 4 | Example 5 |
| Aqueous primer coating composition | | WP-6 | WP-7 | WP-1 | WP-1 | WP-1 |
| Aqueous first colored coating composition | | WD-1 | WD-1 | WD-1 | WD-1 | WD-1 |
| Aqueous second colored coating composition | | WE-1 | WE-1 | WE-1 | WE-1 | WE-1 |
| Clear coating composition | | CC-1 | CC-1 | CC-2 | CC-3 | CC-6 |
| Composition of aqueous primer coating | | | | | | |
| A: Polyolefin | Melting point (° C.) | 80 | 80 | 80 | 80 | 80 |
| resin | Weight average | 120,000 | 120,000 | 120,000 | 120,000 | 120,000 |
| | molecular weight | | | | | |
| B: Polyurethane | Glass transition | −49 | −60 | −83 | −83 | −83 |
| resin | temperature (° C.) | | | | | |
| | Elongation percentage | 530 | 250 | 800 | 800 | 800 |
| | (%) | | | | | |
| Composition | A/B | 25/75 | 25/75 | 28/72 | 28/72 | 28/72 |
| | C/(A + B) | 5/100 | 5/100 | 5/100 | 5/100 | 5/100 |
| | D/(A + B + C) | 7/93 | 7/93 | 7/93 | 7/93 | 7/93 |
| Glass transition temperature (° C.) of | | 84 | 84 | 82 | 82 | 66 |
| clear coating film | | | | | | |
| Elongation percentage (%) of clear | | 2.9 | 2.9 | 3.5 | 3.1 | 5.4 |
| coating film | | | | | | |
| Coating film quality | | | | | | |
| Base material: | Coating film appearance | ◯ | ◯ | ◯ | ◯ | ◯ |
| Electrodeposited | Adhesion | Δ | ◯ | ◯ | ◯ | ◯ |
| sheet | Moisture resistance | Δ | ◯ | ◯ | ◯ | ◯ |
| | (coating film appearance) | | | | | |
| | Moisture resistance | X | ◯ | ◯ | ◯ | ◯ |
| | (adhesion) | | | | | |
| | Chipping resistance | Δ | X | ⊚ | ⊚ | ⊚ |
| Base material: | Coating film appearance | ◯ | ◯ | ◯ | ◯ | ◯ |
| Polypropylene | Adhesion | Δ | ◯ | ◯ | ◯ | ◯ |
| | Moisture resistance | Δ | ◯ | ◯ | ◯ | ◯ |
| | (coating film appearance) | | | | | |
| | Moisture resistance | X | ◯ | ◯ | ◯ | ◯ |
| | (adhesion) | | | | | |
| | Chipping resistance | X | X | X | X | X |

1. A method for forming a multilayer coating film, the method comprising:
a step of simultaneously coating a same aqueous primer coating composition on two coated objects, namely a pre-coated steel sheet and a pre-treated plastic base material for a motor vehicle,
a step of simultaneously coating a same aqueous first colored coating composition on the primer-coated materials using a wet-on-wet process,
a step of simultaneously coating a same aqueous second colored coating composition on the aqueous first colored coating composition-coated materials using the wet-on-wet process,
a step of simultaneously coating a same clear coating composition on the aqueous second colored coating composition-coated materials and
a step of simultaneously curing the formed multilayer coating film,
the method being characterized in that:
(1) the aqueous primer coating composition contains:
an aqueous polyolefin resin (A) having a melting point of 60-100° C. and a weight average molecular weight in a range of 50,000-250,000,
an aqueous polyurethane resin (B) having a glass transition temperature (Tg) of −100° C. to −70° C. and an elongation percentage of 500% or more,
a curing agent (C), and electrically conductive carbon (D),
(2) the aqueous first colored coating composition and the aqueous second colored coating composition each contain a core shell emulsion having an acrylic resin core and a polyurethane resin shell as a base resin, and
(3) the dear coating composition contains a hydroxyl group-containing acrylic resin containing 20 mass % or more of t-butyl methacrylate, a polyisocyanate compound and a melamine resin, and a coating film obtained by curing the clear coating composition has a glass transition temperature (Tg) of 70° C. or higher and an elongation percentage of 3% or less.

2. The method for forming a multilayer coating film as claimed in claim 1, wherein the plastic base material contains at least one type of resin material selected from the group consisting of PP resins, ABS resins, PC resins and ABS/PC resins.

3. The method for forming a multilayer coating film as claimed in claim 1, which is characterized in that a proportion in terms of parts by mass of component (A) and component (B) in the aqueous primer coating composition is 20/80 to 80/20 in terms of resin solid content, a proportion in terms of parts by mass of component (C) and {component (A)+component (B)} is 1/100 to 30/100 in terms of solid content, and furthermore a proportion in terms of parts by mass of component (D) and {component (A)+component (B)+component (C)} is 2/98 to 20/80 in terms of solid content.

4. The method for forming a multilayer coating film as claimed in claim 1, which is characterized in that component (B) in the aqueous primer coating composition is a colloidal dispersion type or emulsion type aqueous polyurethane resin.

5. The method for forming a multilayer coating film as claimed in claim 1, which is characterized in that component (B) in the aqueous primer coating composition is an aqueous polyurethane resin obtained by subjecting a polyurethane, which is obtained by reacting a polyisocyanate with a polyol selected from among a polyester polyol, a polycarbonate polyol and a polyether polyol, to chain extension using a low molecular weight compound having at least 2 active hydrogens in the compound.
